(19) United States
(12) Patent Application Publication
(10) Pub. No.: US 2021/0196078 A1
(43) Pub. Date: Jul. 1, 2021

(54) GRILL DEVICE, COMPONENTS OF GRILL DEVICE, AND RELATED METHODS

(71) Applicant: Traeger Pellet Grills, LLC, Salt Lake City, UT (US)

(72) Inventors: Michael V. Colston, Salt Lake City, UT (US); Brayden Sundstrand, Salt Lake City, UT (US); Brandon Martin, Salt Lake City, UT (US); Daniel A. Altenritter, Layton, UT (US)

(21) Appl. No.: 17/138,407

(22) Filed: Dec. 30, 2020

Related U.S. Application Data
(60) Provisional application No. 62/955,731, filed on Dec. 31, 2019.

(51) Int. Cl. A47J 36/32; F24B 13/04; F23N 1/00; F24C 15/14; F23J 15/02; A47J 37/07; A47J 36/06; A23B 4/052

(52) U.S. Cl. CPC A47J 36/32; F24B 13/04; F23N 1/005; F24C 15/14; F23J 15/02; F24B 13/008; A47J 37/079; A47J 36/06; A23B 4/052; F23N 2229/00; A47J 37/0704

(57) ABSTRACT

A grill device includes a cooking portion assembly including a fire pot assembly, an ash-collection container, a bottom plate extending between the fire pot assembly and the ash-collection container, a drip tray disposed above the fire pot assembly and ash-collection container, a cooking chamber defined above the drip tray, and an expansion chamber defined beneath the drip tray and above the fire pot assembly, the ash-collection container, and the bottom plate, wherein the expansion chamber is configured to facilitate particulate within smoke produced by combustion within the fire pot assembly to fall out of the smoke before the smoke reaches the cooking chamber.

### CROSS-REFERENCE TO RELATED APPLICATION

This application claims the benefit under 35 U.S.C. §119(e) of U.S. Provisional Patent Application Ser. No. 62/955,731, filed Dec. 31, 2019, the disclosure of which is hereby incorporated herein in its entirety by this reference.

### TECHNICAL FIELD

This disclosure relates generally to grill devices and components thereof. In particular, the disclosure relates to grill devices having smoke expansion chambers, sensors to improve combustion, cover opening sensors, internal controllers, and additional components.

### BACKGROUND

Grills and smokers have long been used to prepare food and perform other tasks. For example, outdoor grills and smokers are often used to prepare meats, vegetables, fruits, and other types of food. These grills and smokers are typically operated using manual controls that are integrated into the frame of the grill or smoker. For example, many such outdoor appliances have an ignition button that, when pressed, generates a spark near a gas outlet on a burner. The spark ignites the gas and the burner begins to create heat. The amount of heat is generally controlled using a dial or nob that allows more or less gas to be introduced at the burner.

Furthermore, conventional grills and smokers have a single chamber within which smoke is produced and food products are cooked. This results in ash and other byproducts coming into contact with the food products. Moreover, combustion within conventional grills and smokers is typically just related to temperature management and limited information is utilized when adjusting grill and smoker operation. Additionally, conventional grills and smokers present a significant risk when place too close to other objects (e.g., an exterior wall of a house).

### SUMMARY

Some embodiments include a grill device including a cooking portion assembly. The cooking portion may include a fire pot assembly, an ash-collection container, a bottom plate extending between the fire pot assembly and the ash-collection container, a drip tray disposed above the fire pot assembly and ash-collection container, a cooking chamber defined above the drip tray, and an expansion chamber defined beneath the drip tray and above the fire pot assembly, the ash-collection container, and the bottom plate, wherein the expansion chamber is configured to facilitate particulate within smoke produced by combustion within the fire pot assembly to fall out of the smoke before the smoke reaches the cooking chamber.

Additional embodiments include a grill device including a cooking portion assembly and a controller. The cooking portion assembly may include a fire pot assembly, a flame sensor configured to detect flames within the fire pot assembly, a fuel chamber for housing fuel of the grill device, a fuel sensor disposed within the fuel chamber and configured to detect a fuel feed rate from the fuel chamber into the fire pot assembly; a cover defining a portion of a cooking chamber and openable relative a remainder of the cooking portion assembly, and a lid sensor coupled configured to detect a position of the cover. The controller may be operably coupled to the flame sensor, the fuel sensor, and the lid sensor. The controller may include at least one processor and at least one non-transitory computer-readable storage medium storing instructions thereon that, when executed by the at least one processor, cause the controller to: receive information regarding operation of the grill device from at least one of the flame sensor, the fuel sensor, and or lid sensor; adjust combustion of fuel within the fire pot assembly based at least partially on the received information by adjusting a fuel feed rate; and verify the adjusted fuel feed rate via the fuel sensor.

One or more embodiments include a grill device including a cooking portion assembly and a controller. The cooking portion assembly may include a cooking chamber, a temperature sensor disposed within the cooking chamber, and a plurality of other sensors discrete from the temperature sensors disposed within the cooking portion assembly. The controller may be operably coupled to the temperature sensor and the plurality of other sensors. The controller may include: at least one processor, and at least one non-transitory computer-readable storage medium storing instructions thereon that, when executed by the at least one processor, cause the controller to: receive information regarding operation of the grill device from at least one of the plurality of sensors; and adjust combustion of fuel within the cooking portion assembly based at least partially on the received information.

Some embodiments include a grill device including a cooking portion assembly comprising a cover pivotally coupled to a remainder of the cooking portion assembly, the cover being openable to expose a cooking chamber of the grill device, a cover opener sensor configured to detect motion or a proximity of an object, and a controller operably coupled to the cover opener sensor, the controller comprising: at least one processor; and at least one non-transitory computer-readable storage medium storing instructions thereon that, when executed by the at least one processor, cause the controller to: receive indication from the cover opener sensor that motion has been detected or that an object is proximate the cover opener sensor; and cause the cover of the cooking portion assembly to open.

Additional embodiments include a grill device including a cooking portion assembly and a controller. The cooking portion assembly may include a cooking chamber and a hopper comprising: a housing for holding fuel of the grill device, and one or more radio frequency transparent windows formed in the housing. The controller may disposed within the hopper and for controlling operation of the grill device, the controller including at least one antenna coupled to the housing of the hopper or grill body.

Further embodiments include a grill device including a cooking portion assembly, an outer wall, and a controller. The cooking portion assembly may include a fire pot assembly, an ash-collection container, a bottom plate extending between the fire pot assembly and the ash-collection container, a drip tray disposed above the fire pot assembly and ash-collection container, and a cooking chamber defined above the drip tray. The outer wall may define an exterior of at least a portion of the cooking portion assembly, wherein an air gap is defined between the outer wall and outer surfaces of the fire pot assembly and the ash-collection container. The controller may include at least one processor and at least one non-transitory computer-readable storage medium storing instructions thereon that, when executed by the at least one processor, cause the controller to control operation of the grill device.

One or more embodiments include a grill device including a controller for controlling operation of the grill device and a universal accessory jack operably coupled to the controller of the grill device and configured to accept connectors from a plurality of grill accessories, wherein the controller is configured to determine a type of grill accessory connected to the universal accessory jack.

Some embodiments include a grill device including a controller for controller operation of the grill device and wireless sensors in wireless communication with the controller.

Additional embodiments include a grill device including a cooking portion assembly having a cover defining a portion of a cooking chamber and openable relative a remainder of the cooking portion assembly, wherein the lid or body comprises an exhaust port formed therein and a particulate filter disposed in the exhaust port and configured to filter exhaust escaping the grill device.

Further embodiments include a controller of a grill device. The controller may include a modular printed circuit board. The modular printed circuit board may include a single motherboard having a plurality of connections for receiving other boards, wherein the single motherboard is dedicated to control core operations of the grill device, a plurality of first boards removably coupled to connections of the plurality of connections, each of the plurality of first boards being dedicated to control a respective additional feature of the grill device, and a plurality of second boards removably coupled to connections of the plurality of slots, each of the plurality of first boards being dedicated to control a respective user interface of the grill device.

### BRIEF DESCRIPTION OF THE DRAWINGS

For a detailed understanding of the present disclosure, reference should be made to the following detailed description, taken in conjunction with the accompanying drawings, in which like elements have generally been designated with like numerals, and wherein:

FIG. 1 shows a schematic diagram of an environment in which a grill device of the present disclosure can operate according to one or more embodiments of the present disclosure;

FIG. 2 shows a perspective view of a grill device according to one or more embodiments of the present disclosure;

FIG. 3A is a perspective cross-sectional view of a grill device according to one or more embodiments of the present disclosure;

FIG. 3B is a front side cross-sectional view of the grill device of FIG. 3A;

FIG. 4A is a top perspective view of a grill device according to one or more embodiments of the present disclosure with portions removed to better shown internal components and structure of the grill device;

FIG. 4B is a top perspective view of a drip tray of the grill device of FIG. 4A according to one or more embodiments of the present disclosure;

FIG. 4C is a front side view of the drip tray of FIG. 4B;

FIG. 4D is a top perspective view of a drip tray of the grill device of FIG. 4A according to one or more embodiments of the present disclosure;

FIG. 5A is a top perspective view of a according to one or more embodiments of the present disclosure;

FIG. 5B is a partial side cross-sectional view of a fire pot assembly of the grill device of FIG. 5A;

FIG. 5C is a partial top perspective view of a fire pot assembly of the grill device of FIG. 5A;

FIG. 6A is a top perspective view of a grill device according to one or more embodiments of the present disclosure with some components of the grill device removed to better show internal components and structure of the grill device;

FIG. 6B is a front side cross-sectional view of the grill device of FIG. 6A;

FIG. 6C is a top view of a heat shield of the grill device of FIGS. 6A and 6B;

FIG. 7A is a front cross-sectional view of a grill device according to one or more embodiments of the present disclosure;

FIG. 7B is a side cross-sectional view of the grill device of FIG. 7A;

FIG. 8A is a perspective view of a fire pot assembly of the grill device according to one or more embodiments of the present disclosure;

FIG. 8B is a partial perspective view of a fuel chamber according to one or more embodiments of the present disclosure;

FIG. 9 is a perspective view of a grill device according to one or more embodiments of the present disclosure;

FIG. 10A show a partial perspective view of a cover of a grill device according to one or more embodiments of the present disclosure;

FIG. 10B is an additional partial perspective view of the cover of the grill device of FIG. 10A;

FIG. 11 is a front cross-sectional view of a grill device according to one or more embodiments of the present disclosure;

FIG. 12 is a schematic representation of portions of a grill device according to one or more embodiments of the present disclosure;

FIG. 13 is a perspective view of a grill device according to one or more embodiments of the present disclosure;

FIG. 14 is a rear partial perspective view of the grill device according to one or more embodiments of the present disclosure;

FIG. 15 is a perspective view of a modular printable circuit board of the controller of a grill device according to one or more embodiments of the present disclosure;

FIG. 16 is a schematic representation of portions of a grill device according to one or more embodiments of the present disclosure;

FIG. 17 is a perspective view of a wireless temperature probe according to one or more embodiments of the present disclosure;

FIG. 18A is a rear perspective view of the grill device according to one or more embodiments of the present disclosure;

FIG. 18B is a top view of a shelf of the grill device according to one or more embodiments of the present disclosure;

FIG. 18C is a perspective view of an induction hob according to one or more embodiments of the present disclosure;

FIG. 19 illustrates a block diagram of an example controller of a grill device according to one or more embodiments of the present disclosure;

FIGS. 20A-20C are perspective views of different grates of the grill device according to one or more embodiments of the present disclosure;

FIG. 20D is a perspective view of a cooking accessory according to one or more embodiments of the present disclosure;

FIG. 21 is a perspective view of a cooking accessory according to one or more embodiments of the present disclosure;

FIG. 22 is a wiring schematic of a cooking accessory according to one or more embodiments of the present disclosure; and

FIG. 23 is a perspective view of the grill device according to one or more embodiments of the present disclosure with portions removed to better shown internal components and structure of the grill device.

### DETAILED DESCRIPTION

The illustrations presented herein are not actual views of any grill, wood-pellet grill, or any component thereof, but are merely idealized representations, which are employed to describe embodiments of the present invention.

As used herein, the singular forms following “a,” “an,” and “the” are intended to include the plural forms as well, unless the context clearly indicates otherwise.

As used herein, the term “may” with respect to a material, structure, feature, or method act indicates that such is contemplated for use in implementation of an embodiment of the disclosure, and such term is used in preference to the more restrictive term “is” so as to avoid any implication that other compatible materials, structures, features, and methods usable in combination therewith should or must be excluded.

As used herein, any relational term, such as “first,” “second,” “top,” “bottom,” “upper,” “lower,” “above,” “beneath,” “side,” “upward,” “downward,” etc., is used for clarity and convenience in understanding the disclosure and accompanying drawings, and does not connote or depend on any specific preference or order, except where the context clearly indicates otherwise. For example, these terms may refer to an orientation of elements of a grill device item when utilized in a conventional manner. Furthermore, these terms may refer to an orientation of elements of a grill device as illustrated in the drawings.

As used herein, the term “substantially” in reference to a given parameter, property, or condition means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” used in reference to a given parameter is inclusive of the stated value and has the meaning dictated by the context (e.g., it includes the degree of error associated with measurement of the given parameter, as well as variations resulting from manufacturing tolerances, etc.).

As used herein, the term “grill device” means a grilling and/or smoking device used to grill and/or smoke food. Particularly, the grill devices described herein may be outdoor grill devices configured for grilling and/or smoking food in outdoor environments.

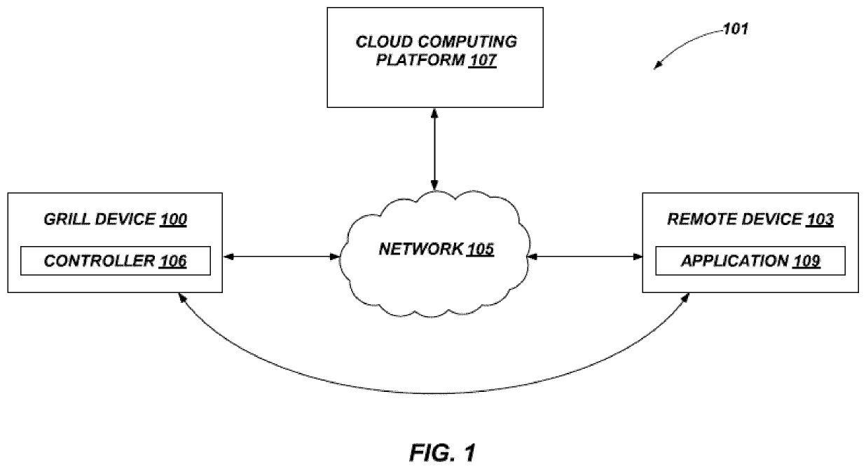

FIG. 1 shows a schematic diagram of an environment 101 in which a grill device 100 of the present disclosure can operate according to one or more embodiments of the present disclosure. As illustrated, the environment 101 includes the grill device 100, a remote device 103, a network 105, and a cloud computing platform 107. The grill device 100, the remote device 103, and the cloud computing platform 107 can communicate via the network 105. The network 105 may include one or more networks, such as the Internet, and can use one or more communications platforms or technologies suitable for transmitting data and/or communication signals. Although FIG. 1 illustrates a particular arrangement of the grill device 100, the remote device 103, the cloud computing platform 107, and the network 105, various additional arrangements are possible. For example, the grill device 100 can directly communicate with the remote device 103, bypassing the network 105.

In one or more embodiments, the grill device 100 may include a controller 106 for controlling operations of the grill device 100 (described herein) at the grill device 100. In some embodiments, the remote device 103 includes an application 109 installed thereon. In one or more embodiments, the application 109 can be associated with the grill device 100. For example, the application 109 enables the remote device 103 to directly interface with the grill device 100 or indirectly interface with the grill device 100 via the cloud computing platform 107. For example, the grill device 100 and the remote device 103 may communicate via any of the manners described in U.S. Pat. No. 10,158,720, to Colston, issued Dec. 18, 2018, U.S. Pat. No. 10,218,833, to Colston, issued Feb. 26, 2019, and U.S. application Ser. No. 15,114,744, to Colston, filed Jul. 27, 2016, the disclosures of which are incorporated in their entireties by reference herein. Furthermore, the remote device 103 and the cloud computing platform 107 may control the grill device 100 via any of the manners described in the aforementioned patents and patent application. Moreover, the application 109, cloud computing platform 107, and grill device 100 may include any of the capabilities of applications, cloud computing platforms, and grill devices described in the aforementioned patents and patent application.

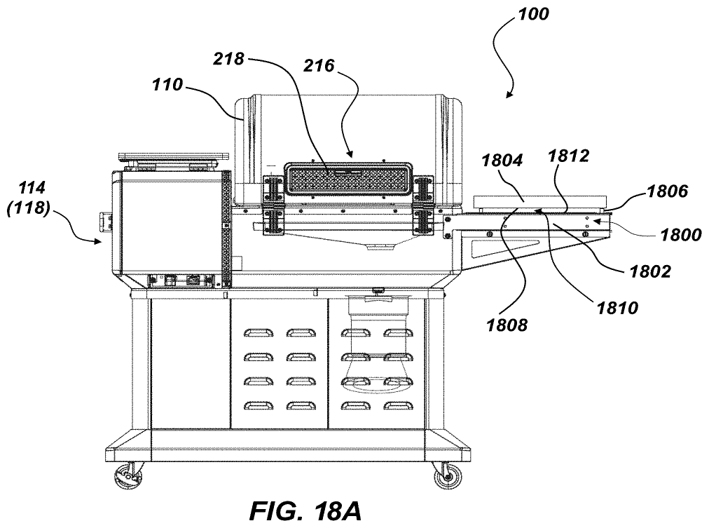

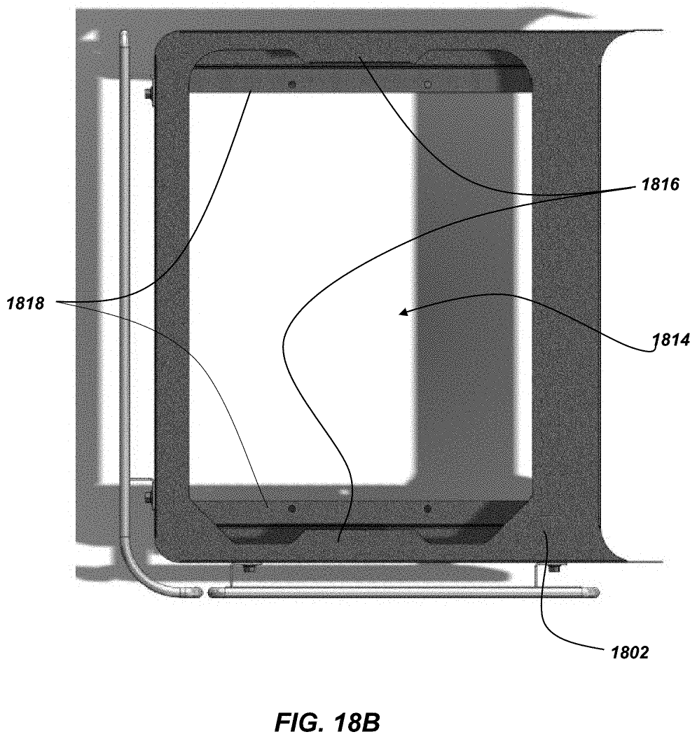

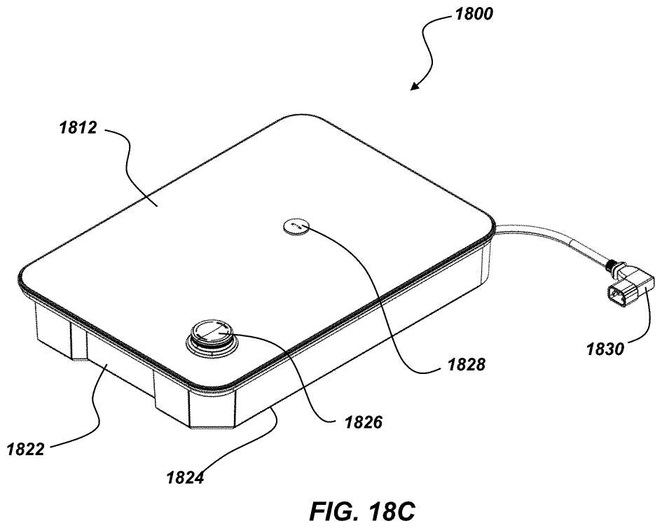

Both the remote device 103 and the controller 106 can represent various types of computing devices with which users can interact. For example, the remote device 103 can be a mobile device (e.g., a cell phone, a smartphone, a PDA, a tablet, a laptop, a smartwatch, a wearable device, a smart speaker, etc.). In some embodiments, however, the remote device 103 can be a non-mobile device (e.g., a desktop or server). Additional details with respect to controller 106 are discussed below with respect to FIG. 18.

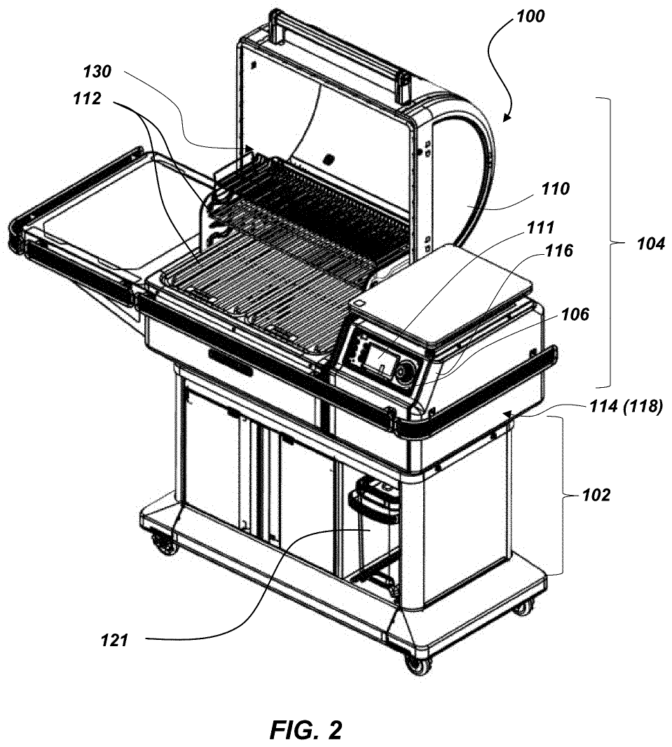

FIG. 2 shows a perspective view of a grill device 100 according to one or more embodiments of the present disclosure. As shown in FIG. 2, the grill device 100 may include a base assembly 102, a cooking portion assembly 104, and a controller 106, such as the controller 106 described above in regard to FIG. 1. The cooking portion assembly 104 may be disposed on the base assembly 102, and the cooking portion assembly 104 may be operably connected to the controller 106. In some embodiments, the base assembly 102 may include one or more storage areas and doors 108. For example, the base assembly 102 may include one or more cabinet assemblies. The cabinet assemblies may provide access to one or more portions of the cooking portion assembly 104, as is discussed in greater detail below. In some embodiments, the base assembly 102 may further include open legs and a bottom shelf for storage.

The cooking portion assembly 104 may include a lid 110, one or more cooking grates 112, a cooking chamber 130, and a fuel chamber 114 (i.e., a hopper 118). In some embodiments, the controller 106 may be at least partially disposed in a housing 116 of the fuel chamber 114. The controller 106 may control a cooking temperature of the grill, control fuel feed rates, control cooking cycles and processes, control fuel burn rates, monitor ambient temperature, monitor internal and external temperatures, monitor fuel levels, monitor grease and ash levels, monitor lid 110 positions, monitor flame presence and levels, control ignition processes, and/or perform other functions. In some embodiments, the controller 106 may control internal temperature of the fuel chamber 114 with a secondary fan.

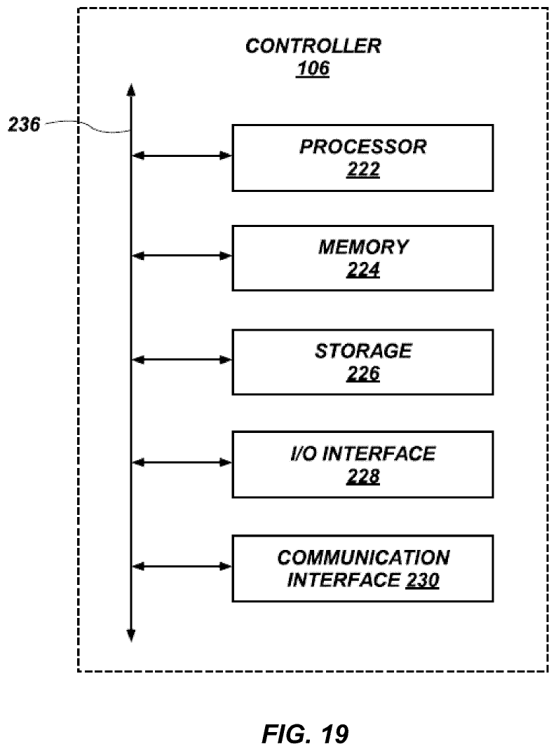

In some embodiments, the controller 106 may include a display 111 for presenting information to a user present a display to a user. For example, the display 111 may be visible from an exterior of the grill device 100. The display 111 may show a variety of operating information and may display one or more graphical user interfaces (GUIs) that allows interaction from user. For example, a GUI may include one or more display regions and active/activatable regions. As used in this disclosure, a display region is a region of a GUI which displays information to a user. An activatable region is a region of a GUI, such as a button, slider, or a menu, which allows the user to take some action with respect to the GUI (e.g., if manipulated). Some display regions are also activatable regions in that the activatable regions display information and enable some action that may be taken by a user. In a contact-sensitive GUI, contacting a contact-sensitive area associated with an activatable region may activate that region (e.g., selecting a GUI button). Activatable regions may be displayed as GUI elements/objects, for example, buttons, sliders, selectable panes, menus, etc., all of various shapes and sizes. In particular, the components (e.g., the activatable regions of the GUI) may allow a user to interact with a collection of display elements for a variety of purposes. As noted above, the controller 106 is described in further detail in regard to FIG. 19.

Referring still to FIG. 2, in some embodiments, the grill device 100 may include a wood-pellet grill. For example, the grill device 100 may utilize wood pellets that are fed to an igniter and fire pot assembly to produce heat and smoke for cooking and preparing food products. In additional embodiments, the grill device 100 may include a charcoal smoker. In further embodiments, the grill device 100 may include a combination of a wood-pellet grill and a charcoal smoker. In yet further embodiments, the grill device 100 may include a gas grill. For instance, the grill device 100 may utilize natural gas and/or propane to produce heat for cooking and preparing food products. In some embodiments, the grill device 100 may include both a wood-pellet grill and a gas grill. For instance, the grill device 100 may utilize wood-pellets and/or gas to heat, cook, and prepare food products. As a non-limiting example, the grill device 100 may include any conventional gas system utilized on grills. For purposed of the present application, the grill device 100 is described as a wood-pellet grill. In other embodiments, the grill device 100 may include an electrically heated grill, such as a grill including an electrical heating element (e.g., induction heating element, resistance heating element, etc.). However, the systems and components described herein are applicable to any of the grills described herein, and all of the above-described grills are within the scope of the present disclosure.

In some embodiments, the grill device 100 may include an additional fuel storage container 121 disposed within the cabinet assemblies in the base assembly 102. For example, the fuel storage container 121 may include a container for holding fuel, such as wood pellets, charcoal briquettes, etc. The container may be a plastic container, a metal container, etc. In some embodiments, the container may include a lid for protecting fuel from external conditions. For example, the lid may include a seal, such as a water tight seal, a weather seal, etc., configured to maintain a dry environment within the fuel storage container 121. In some embodiments, the fuel storage container 121 may be a tank configured to store liquid fuel, such as propane, natural gas, etc. In other embodiments, the fuel storage container 121 may be a container configured to store electrical energy, such as a battery, a capacitor, etc.

In some embodiments, the fuel storage container 121 may be removably coupled to the base assembly 102. For example, the fuel storage container 121 may be coupled to rails on the base assembly 102 configured to enable the fuel storage container to translate in and out of the base assembly 102 on the rails. In some embodiments, the fuel storage container 121 may be coupled to the base assembly 102 with couplers, clamps, latches, etc., such that the fuel storage container 121 may be secured to the base assembly 102 when not being accessed by a user. For example, the fuel storage container 121 may be secured such that movement of the fuel storage container 121 may be limited when the grill device 100 is moved. In some embodiments, the fuel storage container 121 may be sized such that a designated space in the base assembly 102 may substantially limit movement of the fuel storage container 121 such that the fuel storage container 121 may be secured within the base assembly 102 without any additional hardware connections.

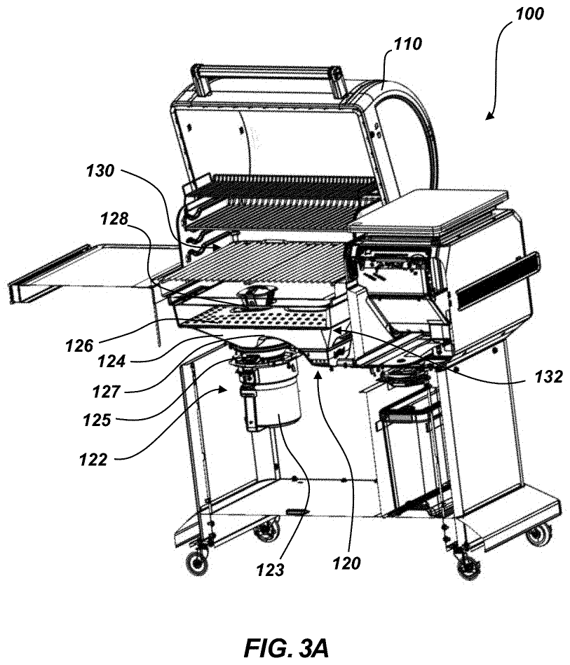

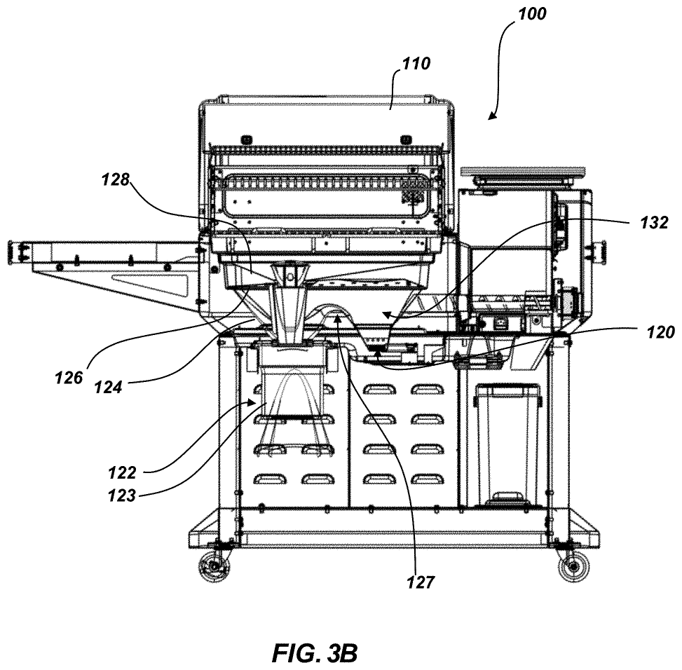

FIG. 3A is a perspective cross-sectional view of a grill device 100 according to one or more embodiments of the present disclosure. FIG. 3B is a front side view of the grill device 100 of FIG. 3A. Referring to FIGS. 3A and 3B together, in one or more embodiments, the cooking portion assembly 104 of the grill device 100 may include a fire pot assembly 120, an ash-collection container 122, a bottom plate 124, a heat shield 126, and a drip tray 128.

In some embodiments, fire pot assembly 120 and the ash-collection container 122 may be disposed beneath the heat shield 126, and the bottom plate 124 may extend between the fire pot assembly 120 and the ash-collection container 122. In one or more embodiments, the bottom plate 124 may have a contoured upper surface. For example, the bottom plate 124 may extend upward from peripheral edges of the fire pot assembly 120 and the ash-collection container 122 and may extend between the fire pot assembly and the ash-collection container 122. In some embodiments, a slope of the bottom plate 124 leading to the fire pot assembly 120 may be steeper than a slope of the bottom plate 124 leading to the ash-collection container 122. Furthermore, the bottom plate 124 may define a peak 127 between the fire pot assembly 120 and the ash-collection container 122. For example, the bottom plate 124 may extend upward from the peripheral edges of the fire pot assembly 120 and the ash-collection container 122 to an outer peripheral edge of the bottom plate and to the peak 127 between the fire pot assembly 120 and the ash-collection container 122. In some instances, the peak 127 may be defined closer to the fire pot assembly 120 than the ash-collection container 122. As a result, surfaces (e.g., portions of the upper surface) of the bottom plate 124 leading to the ash-collection container 122 may be larger in area than surfaces of the bottom plate 124 leading to fire pot assembly 120. As will be described in further detail below, having a larger portion of the bottom plate 124 lead, as a declining slope, to the ash-collection container 122 relative to a portion of the bottom plate leading to the fire pot assembly 120 may result in a higher percentage of ash, particulate, and grease falling into the ash-collection container 122 relative to the fire pot assembly 120 during operation of the grill device 100.

In one or more embodiments, the ash-collection container 122 may include a canister 123 with one or more removable (e.g., disposable) portions (e.g., liners). The canister 123 may be open on an upper longitudinal end thereof, and the canister 123 may be connected to the bottom plate 124 at the upper longitudinal end of the canister 123. During operation, the bottom plate 124 may direct ash that falls onto the bottom plate 124, and any other substances falling on the bottom plate 124 into the canister 123 through the open upper longitudinal end of the canister 123 and into the ash-collection container 122. The drip tray 128 may also direct grease, ash, food products that fall onto the drip tray 128, and any other substances falling on the drip tray 128 into the canister 123 through the open upper longitudinal end of the canister 123. As used herein, the terms grease and ash mean and include all substances and/or by products falling onto the drip tray 128, such as grease, ash, food byproducts, and other substances. In one or more embodiments, a lower portion of the canister 123 may be removable and disposable. In other embodiments, the canister 123 may include a liner that is removable and disposable. In yet further embodiments, the canister 123 may include both a disposable lower portion and a disposable liner.

In view of the foregoing, a combination of geometry of the bottom plate 124, the drip tray 128, and the ash-collection container 122 may reduce a number of components of the grill device 100 that need frequent cleaning in comparison to conventional grill devices. For example, the geometry of the bottom plate 124, the drip tray 128, and the ash-collection container 122 may result in a single container for collection of both ash and grease instead of having a grease catch that is separate and discrete from an ash-collection container. The foregoing may result quicker and easier cleaning processes, may reduce wear on grill components, and may result in longer lifetimes and improved performance of the components of the grill device 100 in comparison to conventional grill devices. In one or more embodiments, the grill device 100 may include a grease sensor 125 positioned on or near and/or within the ash-collection container 122. Furthermore, the grease sensor 125 may be operably connected to the controller 106 and may provide information related an amount (e.g., a level) of material (e.g., grease and ash) in the ash-collection container 122. In one or more embodiments, the grease sensor 125 may include an optical sensor that determines a height of material within the ash-collection container 122. For instance, the grease sensor 125 may include any conventional optical sensor. In additional embodiments, the grease sensor 125 may include a scale (e.g., a spring and plate or any other conventional scale) upon which grease and ash may rest. In some embodiments, the grease sensor 125 may be one or more capacitive probes configured to detect changes in an electrical field surrounding each capacitive probe to determine the presence of another material, such as grease. In some embodiments, the controller 106 may be configured to display a grease level on the display 111 and/or an alert when the ash-collection container 122 is full and/or near full.

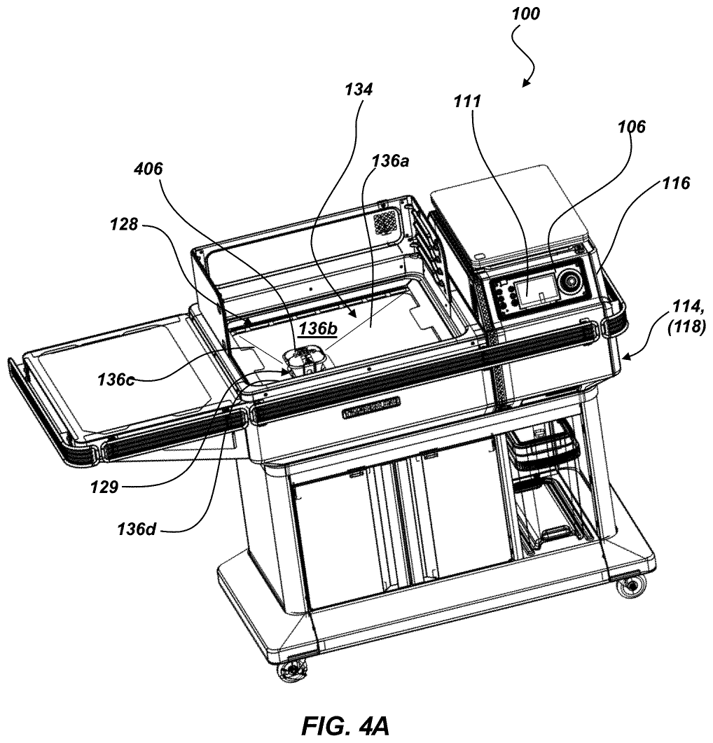

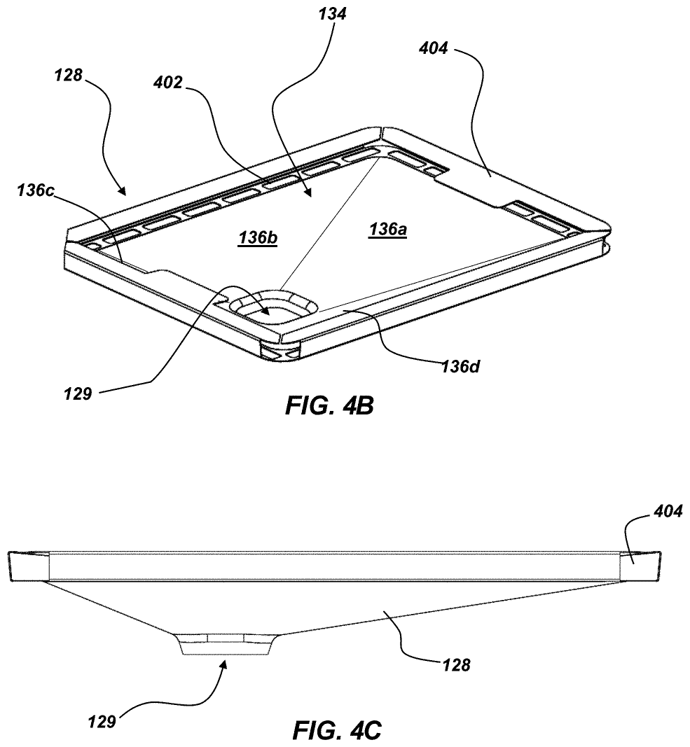

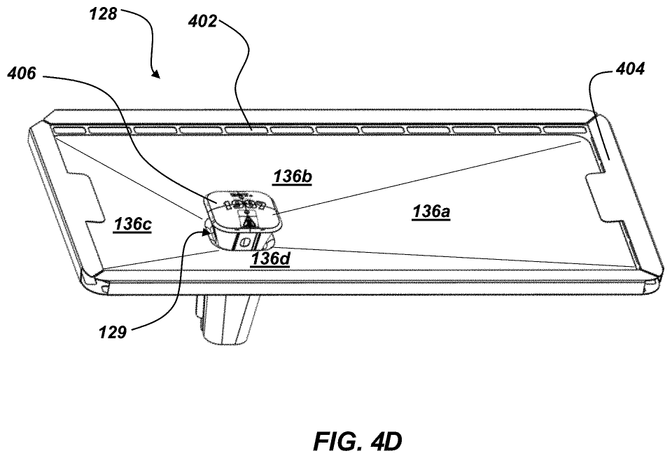

FIG. 4A is a top perspective view of a grill device 100 according to one or more embodiments of the present disclosure with portions removed to better shown internal components and structure of the grill device 100. FIG. 4B is a top perspective view of the drip tray 128 according to one or more embodiments of the present disclosure. FIG. 4C is a side view of the drip tray 128 according to one or more embodiments of the present disclosure. Referring to FIGS. 3A-4C together, the drip tray 128 may be disposed over the heat shield 126. In some embodiments, the drip tray 128 may define a general downward funnel. An opening 129 of the downward funnel may be defined generally above the ash-collection container 122 such that grease falling onto to the drip tray 128 during operation of the grill device 100 may be directed from the drip tray 128 and into the ash-collection container 122. For example, an upper surface 134 the drip tray 128 may include a plurality of distinct sloping surfaces 136a, 136b, 136c, 136d leading to the opening 129 above the ash-collection container 122. In one or more embodiments, the drip tray 128 may form an asymmetrical downward funnel. For example, the opening 129 of the downward funnel may be defined more proximate one end (e.g., a longitudinal end) of the drip tray 128. In other words, the opening 129 may be off-centered. In some embodiments, the drip tray 128 (e.g., a portion of the downward funnel of the drip tray 128) may extend partially through the heat shield 126 to a region above the ash-collection container 122. For example, the heat shield 126 may define a receiving aperture 133 through which the drip tray 128 may extend.

Referring still to FIGS. 3A-4D together, in some embodiments, the drip tray 128 and the lid 110 may define the cooking chamber 130 there between. Furthermore, the grill device 100 may define an expansion chamber 132 in a region between the fire pot assembly 120 (and the bottom plate 124) and a lower surface of the drip tray 128. In some embodiments, the drip tray 128 may act as a barrier between the cooking chamber 130 and the expansion chamber 132.

In operation, the expansion chamber 132 of the grill device 100 may permit ash and particulate (e.g., byproducts) of combustion of fuel to fall out of smoke produced by combustion within the fire pot assembly 120 (described in further detail below). In particular, the expansion chamber 132 may provide a region separated from the cooking chamber 130 where ash and particulate may fall out of the smoke prior to reaching the cooking chamber 130 (e.g., reaching the cooking chamber 130 through the opening 129 of the drip tray 128). Moreover, the ash and particulate may fall onto the bottom plate 124 and eventually into the ash-collection container 122, as described above. Providing an expansion chamber 132 for the smoke to expand and for ash to fall out of the smoke prior to the smoke reaching the cooking chamber 130 may reduce an amount of ash contacting (e.g., falling on) food products in the cooking chamber 130 during operation. As a result, the expansion chamber 132 may assist in yielding a cleaner and more desirable final food product and may keep the cooking chamber 130 cleaner in comparison to convention grills and smokers. In view of the foregoing, the expansion chamber 132 may reduce an amount of required cleaning and maintenance in order to keep the cooking chamber 130 and grill device 100 clean.

In some embodiments, the drip tray 128 may include one or more apertures 402 through the drip tray 128. The one or more apertures 402 may be configured to enable the smoke and/or heat to pass through the drip tray 128 into the cooking chamber 130. For example, the one or more apertures 402 may be arranged about a border of the drip tray 128 such that, during operation, the smoke and/or heat may be at least substantially distributed evenly into the cooking chamber 130 through the drip tray 128. In some embodiments, the drip tray 128 may include one or more cover members 404 positioned over the one or more apertures 402. The one or more cover members 404 may be configured to direct any grease, juices, etc., falling from the cooking chamber 130 onto the drip tray 128, rather than through the one or more apertures 402. The one or more cover members 404 may be configured to enable the grease, juices, etc., to flow along the drip tray 128 through the opening 129 and into the ash-collection container 122 while simultaneously enabling the smoke and/or heat to enter the cooking chamber 130 through the one or more apertures 402 around the border of the drip tray 128. In some embodiments, the one or more cover members 404 may each include a flap extending generally from an outer peripheral edge (e.g., an outer periphery) of the drip tray 128 inward toward the opening 129 of the drip tray 128 and over the apertures 402.

In some embodiments, the drip tray 128 may include a baffle 406. The baffle 406 may be positioned proximate the opening 129 in the drip tray 128. The baffle 406 may be configured to limit the airflow passing through the opening 129. For example, the baffle 406 may create a flow restriction in the opening 129, such that the airflow through the one or more apertures 402 about the border of the drip tray 128 may be increased. Limiting the airflow through the opening 129 and increasing the airflow through the one or more apertures 402 may enable smoke and/or heat to be more evenly distributed within the cooking chamber 130 during operation. The baffle 406 may be configured to limit the airflow through the opening 129 while simultaneously enabling grease and other materials to flow through the opening 129 to the ash-collection container 122. In some embodiments, the baffle 406 may be removably coupled to the drip tray 128. For example, the baffle 406 may be removable to enable the components of the grill device 100 to be cleaned more easily by allowing larger media to pass through the opening without obstruction. In some embodiments, different baffles 406 may have different airflow properties, such that a user may exchange the type of baffle 406 depending on the type of food being cooked in the grill 100 or based on different desired smoke properties.

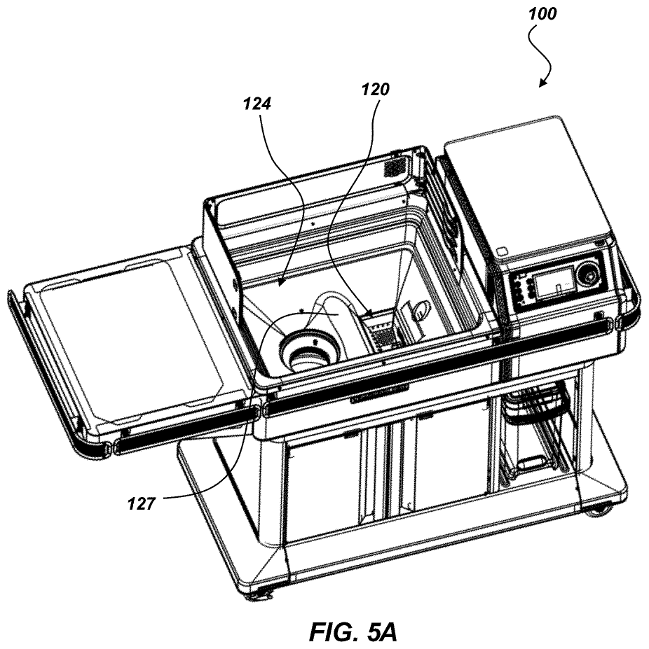

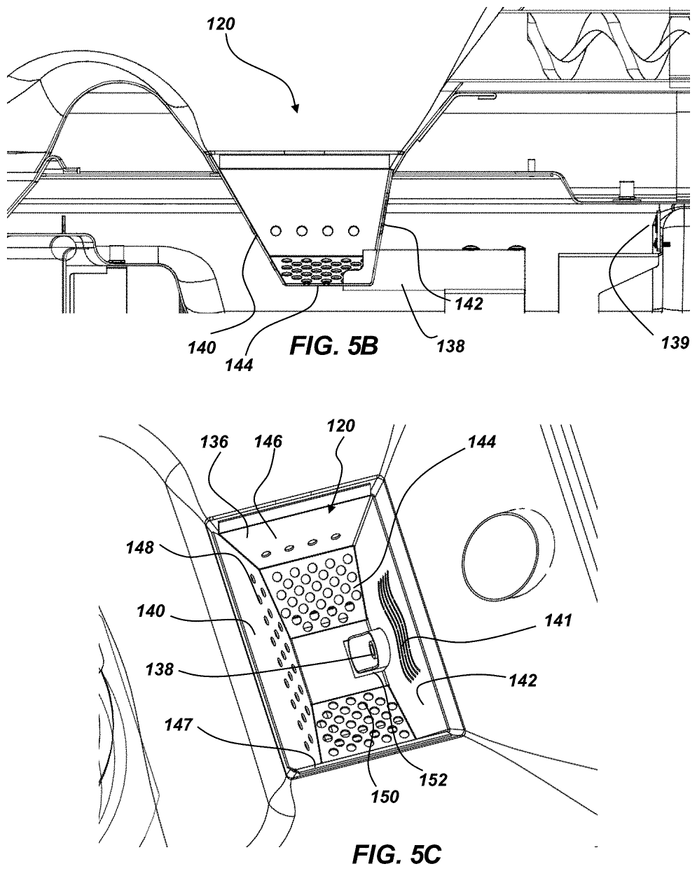

FIG. 5A is a top perspective view of the grill device 100 according to one or more embodiments of the present disclosure with the drip tray 128 and the heat shield 126, among other components, removed to better shown internal components and structure of the grill device 100. FIG. 5B is a partial side cross-sectional view of the fire pot assembly 120 of the grill device 100. FIG. 5C is a partial top perspective view of the fire pot assembly 120 of the grill device 100. Referring to FIGS. 5A-5C together, in some embodiments, the fire pot assembly 120 may include a collection bin 136 and an igniter 138. In one or more embodiments, the collection bin 136 may have a general irregular, block U-shape. For example, the collection bin 136 may include two opposing inclined walls 140, 142 extending upward from a base wall 144. In some embodiments, each of the opposing inclined walls 140, 142 may extend away from a base wall 144 at a different angle. Additionally, the base wall 144 may have a general truncated-V-shape. The collection bin 136 may further include two opposing side walls 146, 147 extending between the two inclined walls 140, 142 at longitudinal ends of the collection bin 136. Each of the two side walls may have general truncated-triangle shape. For example, the collection bin 136 may have a general truncated-triangular prism shape with the truncated end of the triangular prism facing downward.

In some embodiments, each of the two inclined walls 140, 142 may include a plurality of apertures 148 extending through the respective inclined wall. Additionally, the base wall 144 may include a plurality of apertures 150 extending through the base wall 144. The plurality of apertures 148, 150 may enable air-flow into and out of the collection bin 136 during combustion (e.g., burning) of fuel (e.g., wood pellets) within the collection bin 136. Furthermore, the base wall 144 may include a receiving aperture 152 for receiving the igniter 138 and exposing the igniter 138 to fuel (e.g., wood pellets). In some embodiments, the igniter 138 may extend through the receiving aperture 152 into the collection bit 136 to ignite the fuel within the collection bin 136. In other embodiments, the igniter 138 may be a non-contact igniter. The non-contact igniter may be positioned adjacent to the receiving aperture 152 without passing through the receiving aperture 152, such that the igniter 138 may ignite the fuel within the collection bin 136 from outside the collection bin 136 through the receiving aperture 152.

In one or more embodiments, the fire pot assembly 120 may include a flame sensor 139. In some embodiments, the flame sensor 139 may detect the presence and/or an amount/a level of flames within the fire pot assembly 120. For example, the fire pot assembly 120 may include one or more windows 141 (e.g., openings) configured to allow the flame sensor 139 to measure or detect light from the flame in the fire pot assembly 120. The flame sensor 139 may be operably coupled to the controller 106 of the grill device 100 and may provide information to the controller 106 regarding flames or lack thereof to the controller 106. In one or more embodiments, the flame sensor 139 may provide information including one or more of temperature data, an indication of a flame's presence, a flame size, a flame's color, flames brightness, etc., to the controller. In some embodiments, the flame sensor 139 may include one or more of a visible light sensor, an infrared (IF) light sensor (e.g., a near IR array detector or wideband IR flame detector), an IR thermal camera, an optical sensor, a byproduct sensor, a thermocouple, an ultraviolet (UV) detector, an UV/IR detector, a duel IR detector, an ionization current flame detector, etc. In one or more embodiments, the controller 106 may utilize flame recognition technology to confirm the presence of flames by analyzing image data captured by the flame sensor 139.

Referring still to FIGS. 5A-5C, the fire pot assembly 120 of the present disclosure may be advantageous over conventional fire pot assemblies. For example, the two opposing inclined walls 140, 142 extending upward from the base wall 144 may cause fuel (e.g., wood-pellets) to move (e.g., continuously move) downward toward to the base wall 144 during operation, and as a result, the two opposing inclined walls 140, 142 may cause the fuel to move (e.g., continuously move) toward the igniter 138 of the fire pot assembly 120 during operation. In comparison to fire pot assemblies having vertical sidewalls and flat, horizontal base walls, the fire pot assembly 120 of the present disclosure may more efficiently burn fuel (e.g., wood-pellets) and may reduce dead spots of fuel (i.e., regions of fuel within the fire pot assembly 120 remaining motionless during operation and/or not properly burning during operation) within the fire pot assembly 120. Furthermore, the truncated-triangular prism shape of the fire pot assembly 120, in comparison to a cylinder shape of typical fire pots, may increase a percentage of surface area of a collection of fuel (e.g., wood pellets) within the fire pot assembly 120 that is exposed to airflow. The increased surface area of the collection of fuel being exposed to airflow may improve a combustion of the fuel (e.g., increase a heat of the combustion, reduce waste of the combustion, etc.) within the fire pot assembly 120 of the grill device 100. In some embodiments, the apertures 150 in the base wall 144 may substantially prevent buildup of ash, which may increase the interval between cleanings for the fire pot assembly 120.

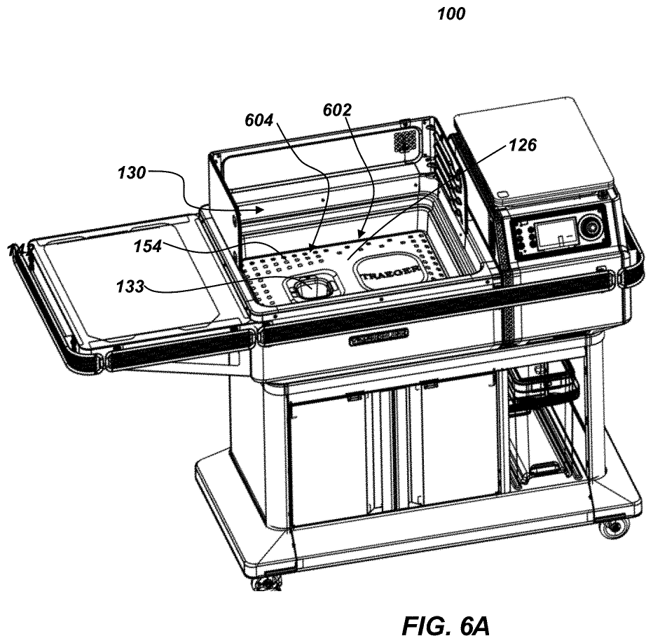

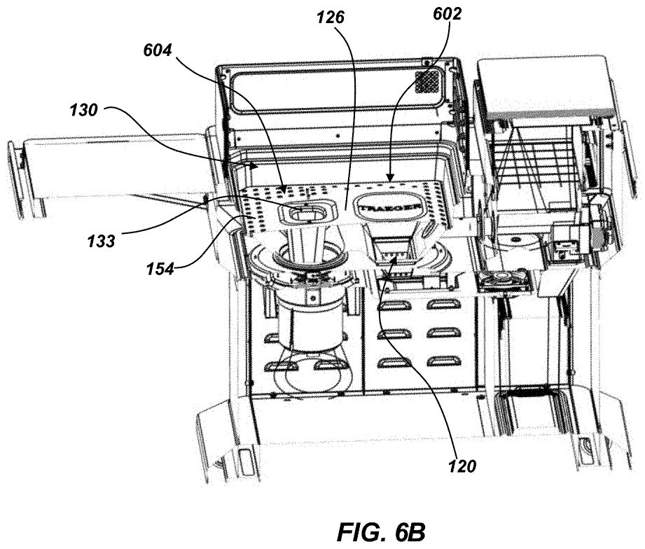

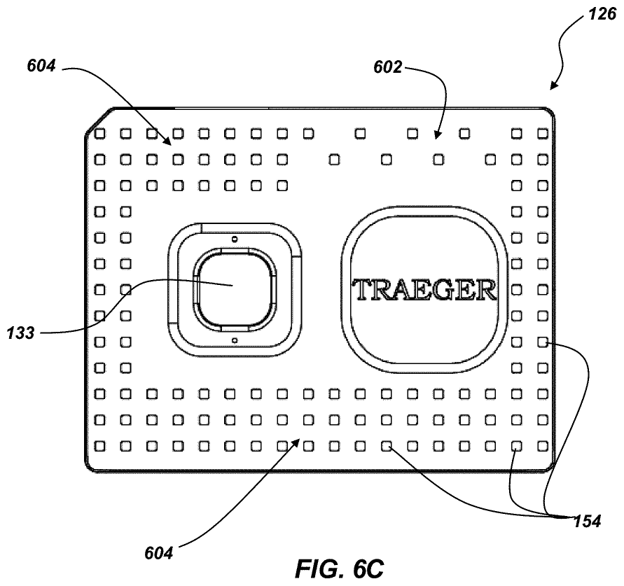

FIGS. 6A-6C illustrate different views of the heat shield 126. FIG. 6A is a top perspective view of the grill device 100 with some components of the grill device 100 removed to better show internal components and structure. FIG. 6B is a top perspective cross-sectional view of the grill device 100 with some components of the grill device 100 removed to better show internal components and structure of the grill device 100. FIG. 6C is a top view of the heat shield 126. In some embodiments, the heat shield 126 of the grill device 100 may include a plurality of apertures 154 extending through the heat shield 126. In some embodiments, a concentration of the plurality of apertures 154 in the heat shield 126 may increase as a distance from the fire pot assembly 120 increases. For example, in a region directly above the fire pot assembly 120, the heat shield 126 may not include minimal or any apertures 154, and as a distance from the fire pot assembly 120 increases along the heat shield 126, the apertures 154 may commence, and the amount of apertures 154 per unit area of the heat shield 126 may increase. As a result, an amount of material forming the heat shield 126 may decrease as the amount of apertures 154 increases.

The increasing concentration of apertures 154 across a longitudinal length of the heat shield 126 may more evenly distribute heat produced by the fire pot assembly 120 across a longitudinal length of the cooking chamber 130 of the grill device 100. For example, the increased density of apertures 154 may permit and encourage smoke and heat produced by the fire pot assembly 120 to pass through areas of the heat shield 126 distal from the fire pot assembly 120. As a result, more heat produced by the fire pot assembly 120 may reach areas of the cooking chamber 130 distal to the fire pot assembly 120 via convection, and more heat may reach areas of the cooking chamber 130 proximate the fire pot assembly 120 via conduction and radiation. As a result, overall heat reaching the cooking chamber 130 through the combinations of convection, conduction, and radiation may provide a more even temperature across a longitudinal length of the cooking chamber 130. Additionally, the receiving aperture 133 of the heat shield 126 may also enable more airflow and heat produced by the fire pot assembly 120 to pass through the heat shield 126 in areas distal to the fire pot assembly 120 via convection. For example, as discussed above, the receiving aperture 133 may be oriented more proximate a longitudinal end of the grill device 100 opposite the fire pot assembly 120.

In some embodiments, the plurality of apertures 154 may be arranged in a pattern along the surface of the heat shield 126. The pattern may define one or more low density areas 602 having a reduced number of apertures 154 and one or more high density areas 604 having an increased number of apertures 154. FIG. 6C illustrates that the apertures 154 may be arranged in one or more rows and one or more columns. The low density areas 602 may include larger spaces between each row and/or each column than in the high density areas 604. In some embodiments, the low density areas 602 may include one or more spaces between apertures 154 where no apertures are formed. For example, the apertures 154 may alternate rows and columns in the low density areas 602, as illustrated in FIG. 6C, thereby decreasing a density of the apertures 154 in the low density area 602. The high density areas 604 may include additional rows and/or columns of apertures in a similarly sized area. For example, the high density areas 604 may include an additional row of apertures 154 relative to low density areas 602, as illustrated in FIG. 6C. In some embodiments, within the high density areas 604, a distance between each row and/or column may be smaller than a correlating distance between each row and/or column within the low density areas 602 such that each aperture 154 within the high density areas 604 is closer to an adjacent aperture than the apertures 154 within the low density areas 602.

In some embodiments, the apertures 154 may be formed within the heat shield 126 during a forming process such as forging or pressing. In other embodiments, the apertures 154 may be formed in a later a mechanical process, such as drilling, punching, cutting, etc. In some embodiments, the apertures 154 may be circular shapes, such as circles, ovals, ellipses, etc. In some embodiments, the apertures may have rectangular shapes, such as squares, rectangles, etc. In other embodiments, the apertures may have other different shapes, such as trapezoids, triangles, hexagons, octagons, starts, etc.

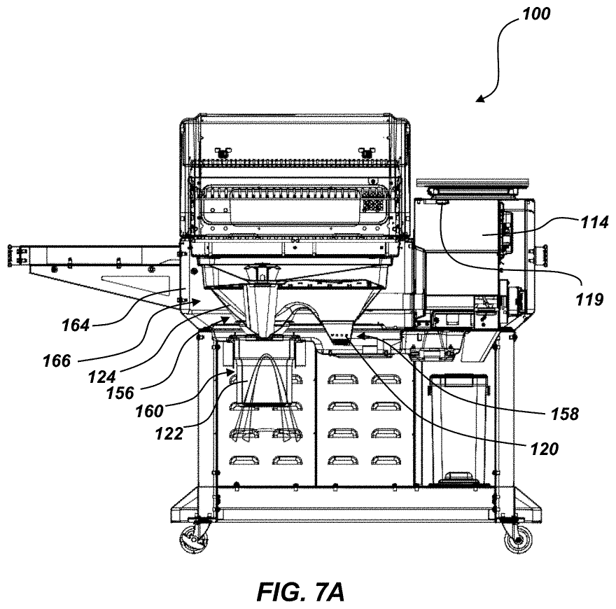

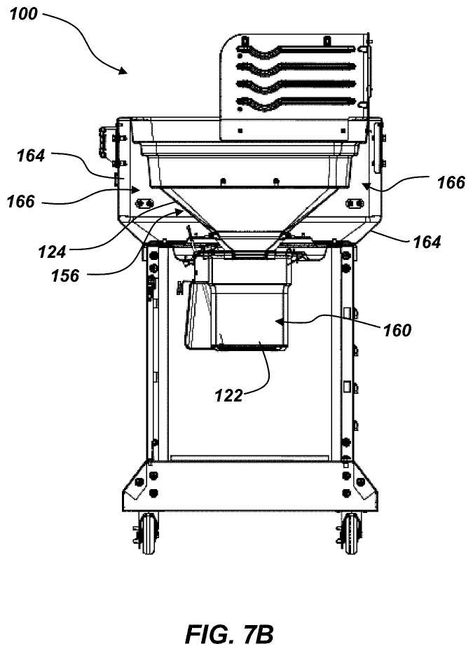

FIG. 7A is a front cross-sectional view of the grill device 100 according to one or more embodiments of the present disclosure. FIG. 7B is a side cross-sectional view of the grill device of FIG. 7A. In some embodiments, an outer surface 156 of the bottom plate 124, an outer surface 158 of the fire pot assembly 120, and an outer surface 160 of the ash-collection container 122 may be separated from an outer wall 164 of the grill device 100 by an air gap 166. In some embodiments, the air gap 166 may be present around substantially all of the outer surfaces of the bottom plate 124, the fire pot assembly 120, and the ash-collection container 122 facing the outer wall 164 of the grill device 100. Furthermore, the air gap 166 may provide insulation between the bottom plate 124, the fire pot assembly 120, and ash-collection container 122 and an exterior of the grill device 100. As a result, the air gap 166 may reduce an amount of heat that reaches the outer wall 164 of the grill device 100 and may at least partially prevent the outer wall 164 of the grill device 100 from reaching relatively (e.g., dangerous) high temperatures. In view of the foregoing, by reducing an amount of heat that reaches the outer wall 164 of the grill device 100, the air gap 166 may reduce an exterior temperature of the grill device 100, reduce a risk of being burned by the grill device 100, and may enable the grill device 100 to be placed closer (i.e., more proximate) to other objects (e.g., a wall of a house) without risk of damaging the object and/or causing a fire. In some embodiments, the air gap 166 may have a width within a range of about 1 inch and about 6 inches. For example, the air gap 166 may have a width of about 2.5 inches

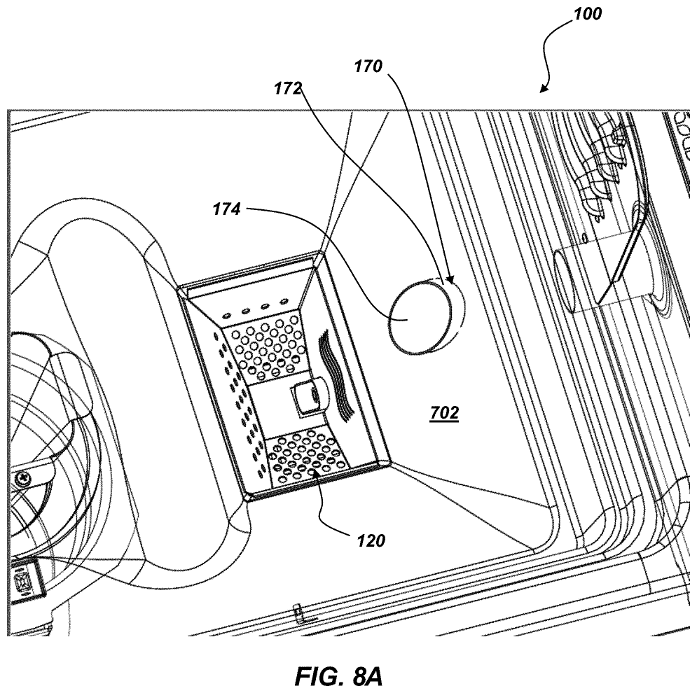

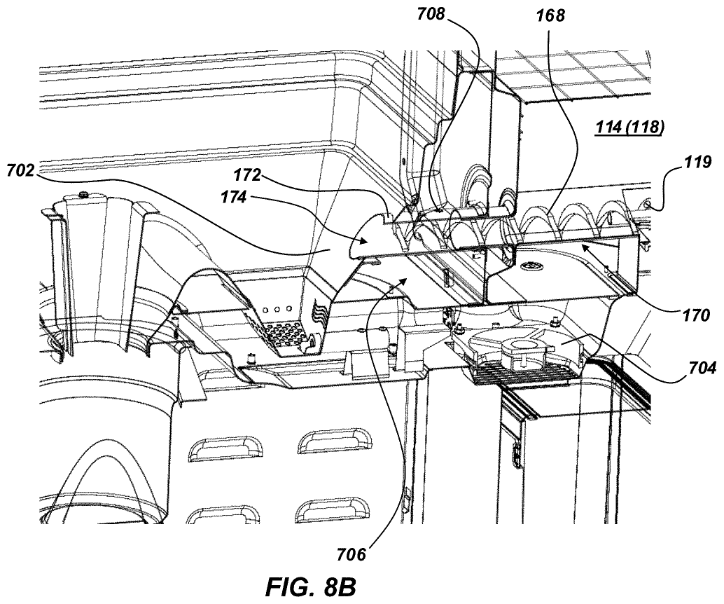

In some embodiments, the grill device 100 may include a fuel sensor 119 disposed within the fuel chamber 114. In some embodiments, the fuel sensor 119 may be positioned in an upper portion of the fuel chamber 114, such that a field of view of the fuel sensor 119 may be directed at an upper surface of fuel within the fuel chamber 114. In some embodiments, the fuel sensor 119 may include multiple sensors in different positions within the fuel chamber 114. For example, a first sensor may be positioned in the upper portion of the fuel chamber 114 and a second sensor may be positioned in a bottom portion of the fuel chamber 114, as described below with respect to FIG. 8B. Examples of fuel sensors are described in U.S. Patent Application Publication No. 2020/0214503, filed Jan. 3, 2020 and titled PELLET GRILLS HAVING PELLET LEVEL DETECTION SYSTEMS AND RELATED METHODS, the disclosure of which is incorporated herein, in its entirety, by this reference.

The fuel sensors 119 may be operably coupled to the controller 106 and may provide any detected/sensed information to the controller 106. Furthermore, in some embodiments, the fuel sensor 119 may further include a fuel-delivery sensor. For example, the fuel sensor 119 may detect a rate at which fuel (e.g., pellets) are delivered to the fire pot assembly 120 through the fuel movement assembly 170. For instance, the fuel sensor 119 may include a mechanical switch to sense a flow rate of fuel into the fire pot assembly 120. In additional embodiments, the fuel sensor 119 may further include a fuel level sensor. For example, the fuel sensor 119 may detect an amount (e.g., a level) of fuel within the hopper 118. In some embodiments, the fuel sensor 119 may include an optical sensor (e.g., beam break sensor, retroreflective optical sensor, etc.), a mechanical sensor (e.g., switch), a scale, an infrared light sensor, or any other conventional sensor for detecting a presence or amount of a material. In one or more embodiments, the fuel sensor 119 may include a plurality of sensors and may include both a fuel delivery sensor and a fuel level sensor. In further embodiments, the fuel sensor 119 may include a fuel (e.g., pellet) humidity and condition sensor. In yet further embodiments, the fuel sensor 119 may include a sensor for determining a type of fuel (e.g., a type of wood pellets) disposed within the fuel chamber 114. For example, pellet condition may be determined by several different types of sensors, such as weight sensors, humidity sensors, capacitance sensors, radio frequency (RF) sensors, etc. In some embodiments, the fuel chamber 119 may also include a light configured to illuminate the interior of the fuel chamber 119, such as for visual inspection. For example, the light may be integrated into the fuel sensor 119.

In some embodiments, the grill device 100 may include a sensor in the hopper for measuring a weight of the pellets over time, and the controller 106 may compare the weight with times when fuel is not being used. Thus, moisture in the pellets may be detected by changing weight over time when the fuel is not being used. In some embodiments, humidity inside the hopper may also be measured to determine the moisture content of the pellets. Moisture content may affect the pellets capacitance and/or RF permeability. In some embodiments, the moisture content may be determined by measuring capacitance of the pellets and/or RF permeability of the pellets in the hopper. In some embodiments, sensor detectable additives such as small amounts of iron may be added to different types of pellets, such that a sensor of the grill device 100, such as an inductive sensor may be used to determine the type of pellets in the hopper.

FIG. 8A is a perspective view of the fire pot assembly 120 of the grill device 100 according to one or more embodiments of the present disclosure. FIG. 8B is a partial perspective view of the fuel chamber 114 according to one or more embodiments of the present disclosure. Referring to FIGS. 8A and 8B, the fuel chamber 114 may include the hopper 118 for housing fuel (e.g., wood-pellet), a fuel sensor 119, and a fuel movement assembly 170.

The fuel movement assembly 170 may lead from the hopper 118 of the grill device 100 to the fire pot assembly 120 of the grill device 100. The fuel movement assembly 170 may include an auger shaft 168, a cylindrical tube 172 extending from the hopper 118 (e.g., an auger conveyor), a motor 173, and an opening 174 at a longitudinal end of the cylindrical tube 172 opposite the hopper 118. The auger shaft 168 may be disposed within the cylindrical tube 172 and within the hopper 118 in a conventional manner. Furthermore, the auger shaft 168, the hopper 118, and the cylindrical tube 172 may operate in a conventional manner to transport fuel (e.g., wood pellets) from the hopper 118 and to the fire pot assembly 120. For instance, the auger shaft 168 may include a helical screw blade (e.g., an Archimedes'screw) that rotates to move fuel out of the hopper 118 and along a length of the cylindrical tube 172 (e.g., from the hopper 118 to the fire pot assembly 120).

In some embodiments, the opening 174 may be oriented above the fire pot assembly 120 such that fuel may fall from the opening 174 and into the fire pot assembly 120. For example, in operation, the auger shaft 168 may rotate within the cylindrical tube 172 and may move fuel (e.g., wood pellets) from the hopper 118 and through the cylindrical tube 172 to the opening 174 of the cylindrical type 172. Upon reaching the opening 174, the fuel may fall from the opening and into the fire pot assembly 120. Loading fuel into the fire pot assembly 120 from a location above the fire pot assembly 120 may provide advantages over conventional fire pot assemblies. For instance, during operation (e.g., when fuel within the fire pot assembly 120 is ignited) loading the fuel (e.g., wood pellets) into the fire pot assembly 120 from a location above the fire pot assembly 120 may increase a likelihood that the fuel comes into contact with ignited (i.e., already ignited) fuel upon entering the fire pot assembly 120. Furthermore, dropping the fuel (e.g., wood pellets) into the fire pot assembly 120 from a location above the fire pot assembly 120 may avoid moving/disrupting ignited fuel away from the igniter 138 in comparison to conventional fire pot assemblies that load fuel at a bottom of collection bins. Moreover, by not having to move fuel in order to load fuel into the collection bin 136 of the fire pot assembly 120, stresses on the auger shaft 168 may be reduced during operation, and the auger shaft 168 and cylindrical tube 172 may provide a more consistent and predictable flow rate of fuel into the fire pot assembly 120. In view of the foregoing, achieving a more consistent and predictable flow rate may result in more predictable operations and combustion within the fire pot assembly 120 of the grill device 100.

In some embodiments, the bottom plate 124 may include angled walls 702 configured to direct the fuel to an ignition point within the fire pot assembly 120. The angled walls 702 may enable the opening 174 in the cylindrical tube 172 to be positioned in an area that is not directly above the ignition point of the fire pot assembly 120. The foregoing may enable heat and smoke from the fire pot assembly 120 to rise to the cooking chamber 130 substantially unobstructed by the cylindrical tube 172. The position of the opening 174 in the cylindrical tube 172, may also enable the cylindrical tube 172 and associated auger shaft 168 to be shorter, which may reduce the strain on the auger shaft 168 and associated motor or drive system.

As noted above, the fuel chamber 114 may include one or more fuel sensors 119. The fuel sensors 119 may be operably coupled to the controller 106 and may provide any detected/sensed information to the controller 106. One or more of the fuel sensors 119 may be positioned on or near the fuel feeder assembly 170 and may be configured to detect properties of the fuel as the fuel enters the fuel feeder assembly 170.

In some embodiments, the fuel feeder assembly 170 may be configured to provide a positive pressure in the cylindrical tube 172 generating an airflow out of the cylindrical tube 172 toward the fire pot assembly 120. In some embodiments, the airflow out of the cylindrical tube 172 may substantially prevent ignition of the fuel within the cylindrical tube 172 and/or the hopper 118.

Ignition of the fuel within the hopper 118 is commonly referred to in industry as “back-burn” and is an undesirable condition as it may result in loss of fuel, damage to the grill device, and possibly injury to the user. Furthermore, positive pressure in the cylindrical tube 172 may also substantially prevent the flow of heated air into the fuel chamber 114, substantially preventing any degradation of the fuel that may be caused by heated air in the fuel chamber 114. Creating a positive pressure in the cylindrical tube 172 may substantially prevent a back-burn condition. Additionally, generating airflow through the cylindrical tube 172 toward the fire pot assembly 120 may help to prevent clogging and/or jams of the fuel within the cylindrical tube 172 while delivering fuel to the fire pot assembly 120.

The positive pressure in the cylindrical tube 172 may be created by a pressurization device 704 configured to generate airflow, such as a fan, pump, air compressor, etc. In some embodiments, the pressurization device 704 may be configured to pressurize air within an air box 706. Furthermore, the cylindrical tube 172 may pass through the air box 706 between the hopper 118 and the fire pot assembly 120. As illustrated in FIG. 8B, the pressurization device 704 may be positioned in an area of the grill device 100 that is outside the air box 706 and the pressure may be ducted into or from the air box 706, such as through passageways, ducts, openings, etc. In some embodiments, the pressurization device 704 may be position with an outlet directly into the air box 706. The cylindrical tube 172 may include a port 708 in a sidewall of the cylindrical tube 172. The port 708 may be configured to allow air to pass from the air box and through the port 708 into the cylindrical tube 172, such that the air pressure within the air box 706 may pass into the cylindrical tube 172 through the port 708 and out the opening 174 at the end of the cylindrical tube 172. Thus, the air pressure within the air box 706 created by the pressurization device 704 may generate an airflow through the cylindrical tube 172 from the port 708 to the opening 174 and toward the fire pot assembly 120.

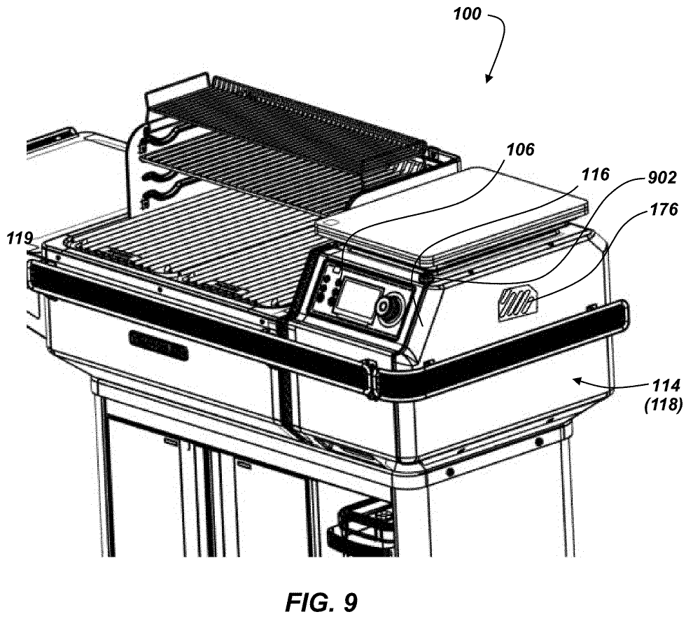

FIG. 9 is a perspective view of the grill device 100 of FIG. 1 according to one or more embodiments of the present disclosure. In one or more embodiments, the grill device 100 may include one or more radio frequency (RF) transparent windows 176 formed the in the fuel chamber 114 (i.e., the hopper 118). The RF transparent windows 176 may be substantially RF transparent (e.g., permit radio frequencies to pass through the RF transparent windows 176). In some embodiments, the RF transparent windows 176 may selectively allow radio frequencies to pass through the RF transparent windows 176. For example, the RF transparent windows 176 may be configured to allow radio frequencies between about 10 kilohertz (kHz) and about 10 Gigahertz (GHz), such as between about 10 megahertz (MHz) and about 5 GHz, or between about 1 GHz and about 5 GHz.

In some embodiments, the RF transparent windows 176 may be formed from a different material than the surrounding portions of the fuel chamber 114 (i.e., the hopper 118) of the grill device 100. For example, the RF transparent windows 176 may be formed from a polymer material, such as polytetrafluoroethylene (PTFE, Teflon®), polyphenol (PPL), polypropylene (PP), polyvinyl chloride (PVC), acrylonitrile butadiene styrene (ABS), etc. In some embodiments, the RF transparent windows 176 may be formed from a quartz material. In some embodiments, the RF transparent windows 176 may be formed from a composite material, such as fiber glass.

In some embodiments, the RF window 176 may be formed from a material having a high heat tolerance, such that the RF window 176 may withstand heat generated within the grill device 100. In some embodiments, the RF window 176 may include a coating configured to allow RF signals to pass through the coating and increase the heat tolerance of the RF window 176 material. For example, the RF window 176 may be coated with a germanium coating, indium tin oxide (ITO) coating, ceramic coating, etc.

In some embodiments, the RF transparent windows 176 may be form a portion of the hopper 118 (i.e., housing 116 of the fuel chamber 114) to permit radio frequencies to reach an antenna (described below) of the controller 106 of the grill device 100. In some embodiments, at least a portion of a side wall of the hopper 118 may be formed from the RF transparent material. In additional embodiments, a wall of the hopper 118 or the housing 116 may include a hole or opening having a plug formed from an RF material may be positioned within the hole or opening forming the RF transparent window 176.

As noted above, the controller 106 may include an antenna. The antenna may be configured to send and/or receive radio frequency signals. For example, the antenna may be configured to communicate with an external device such as a mobile device, an access point (e.g., router), an additional controller, a remote computer, a smart speaker, etc. The antenna may communicate with the remote device through a radio frequency signal such as BLUE TOOTH®, WIFI™, ZIGBEE®, Z-WAVE®, 6LoWPAN, 3G, 4G, 5G, LTE (e.g., LTE CATO, LTE CAT1, LTE CAT3, LTE-M1), NB-IoT, NFC, SIGFOX®, etc. The RF transparent window 176 may enable the antenna of the controller 106 to be positioned within the body (e.g., the hopper 118) of the grill device 100 and communicate with an external device through a wall of the body of the grill device 100. For example, the antenna may be positioned in the housing 116, such as in the fuel chamber, in the hopper 118, in the expansion chamber 132, in the cooking chamber 130, etc.

Positioning the antenna within the body of the grill device 100 may protect the antenna from impact and other potential damage during use, such as damage caused by contact with other items and the antenna, damage caused by exposure to the elements, etc. In some embodiments, positioning the antenna within the body of the grill device 100 may provide a clean and the aesthetic external appearance for the grill, without an antenna extending from a side of the grill device 100 interrupting otherwise clean lines (e.g., straight lines, curved lines, uniform lines, etc.) of the grill device 100.

In some embodiments, the grill device 100 may include an external antenna 902. The external antenna 902 may be configured to send and/or receive radio frequency signals to/from an external device such as a mobile device, an access point (e.g., router), an additional controller, a remote computer, a smart speaker, etc. The external antenna 902 may be positioned in a protected portion of the grill device 100, such as on or near the controller 106. The external antenna 902 may provide an omnidirectional signal with high gain and sensitivity. In some embodiments, the grill device 100 may include both an internal antenna and an external antenna 902. For example, the external antenna 902 may be removable, such that the external antenna 902 may be coupled to the grill device 100 if the signal from the internal antenna has an insufficient range.

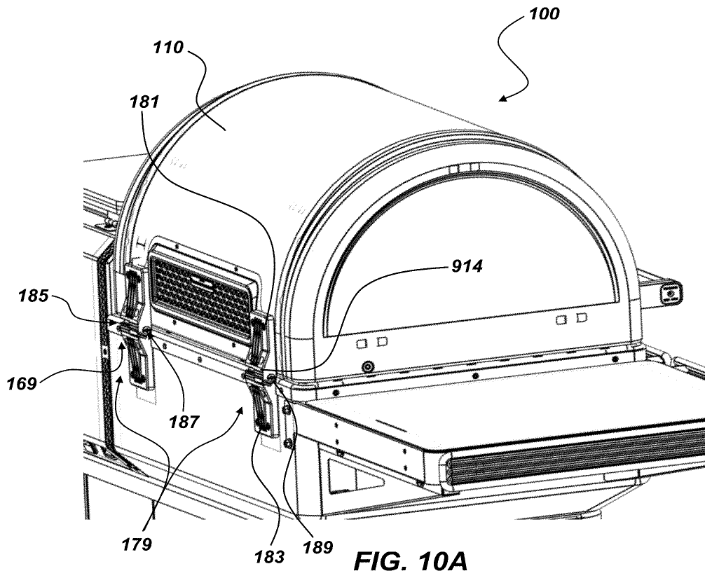

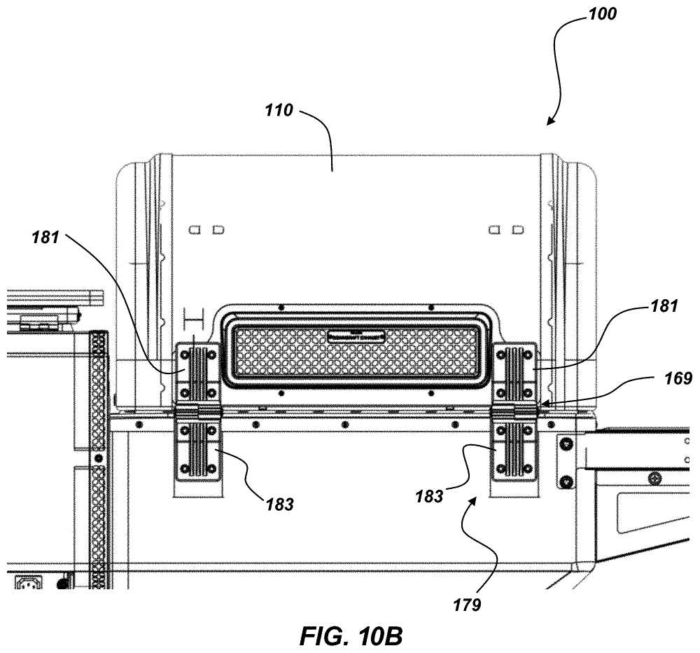

FIG. 10A show a partial perspective view of the lid 110 of the grill device 100 according to one or more embodiments of the present disclosure. FIG. 10B is an additional partial perspective view of the lid 110 of the grill device 100 of FIG. 10A. Referring to FIGS. 10A and 10B together, in some embodiments, the lid 110 may be coupled to the cooking portion assembly 104 of the grill device 100 via one or more hinges 179.

In one or more embodiments, the hinges 179 may include a cover connection portion 181 and a body connection portion 183. In some embodiments, the cover connection portion 181 may be coupled to an exterior portion of the lid 110. In some instances, the lid 110 may include at least two cover connection portions 181. The at least two cover connection portions 181 may be positioned on opposing ends of the lid 110. In some embodiments, the cover connection portion 181 may be coupled to the lid 110 through a hardware connection, such as a bolted connection (e.g., bolt and nut, bolt and threaded insert (i.e., rivet nut, rivnut, nutsert, etc.), etc.), one or more rivets, screws, studs, notch and groove, etc. In some embodiments, the cover connection portion 181 may be coupled to the cover 100 semi-permanently, such as through an adhesive (e.g., glue, epoxy, etc.). In additional embodiments, the cover connection portion 181 may welded, soldered, brazed, etc., to the lid 110.

The body connection portion 183 may be coupled to an exterior portion of the cooking portion assembly 104 of the grill device 100. In some embodiments, the body connection portion 183 may be coupled to the cooking portion assembly 104 through a hardware connection, such as a bolted connection (e.g., bolt and nut, bolt and threaded insert (i.e., rivet nut, rivnut, nutsert, etc.), etc.), one or more rivets, screws, studs, notch and groove, etc. In some embodiments, the body connection portion 183 may be coupled to the cooking portion assembly 104 of the grill device 110 semi-permanently, such as through an adhesive (e.g., glue, epoxy, etc.). In additional embodiments, the body connection portion 183 may welded, soldered, brazed, etc., to the cooking portion assembly 104.

In one or more embodiments, the cover connection portion 181 may have a general triangular shape having one rounded corner. Likewise, the body connection portion 183 may have a general triangle shape having one rounded corner. The cover connection portion 181 and the body connection portion 183 may extend from the exterior portions of the respective lid 110 and cooking portion assembly 104 of the grill device 100. The cover connection portion 181 and the body connection portion 183 may be coupled together at a pivot point 185. The pivot point 185 may be offset from a remainder of the grill device 100 (e.g., the base assembly 102 and cooking portion assembly 104). In some embodiments, the pivot point 185 may include substantially concentric holes 187 formed in each of the cover connection portion 181 and the body connection portion 183. The cover connection portion 181 and the body connection portion 183 may be coupled together via a cylindrical coupling 189 extending through the concentric holes 187. In some embodiments, the cylindrical coupling 189 may include a pin, such as a clevis pin, a locking pin, etc. In additional embodiments, the cylindrical coupling 189 may include a hardware connection, such as a bolted connection, a screw connection, a rivet, etc.

In some embodiments, the cover connection portions 181 may be spaced apart from each other by a distance greater than a distance by which the body connection portions 183 are spaced apart, such that when the cover connection portions 181 are coupled to the body connection portions 183, the cover connection portions 181 abut against an outer surface of each of the body connection portions 183, as illustrated in FIG. 10A. In other embodiments, the cover connection portions 181 may be spaced apart from each other by a distance smaller than a distance by which the body connection portions 183 are spaced apart, such that when the cover connection portions 181 are coupled to the body connection portions 183, the cover connection portions 181 abut against an inner surface of each of the body connection portions 183.

In some embodiments, the cover connection portions 181 and the body connection portions 183 may be positioned at substantially the same distance apart. For example, the body connection portions 183 may include a first arm and a second arm. The first arm and the second arm may define a space between the first arm and the second arm. In some embodiments, the space between the first arm and the second arm may be substantially the same width as a width of the cover connection portion 181. The body connection portion 183 may be configured to receive the cover connection portion 181 in the space between the first arm and the second arm, such that the cover connection portion 181 is sandwiched between the first arm and the second arm of the body connection portion 183 forming a knuckle joint. In some embodiments, the cover connection portions 181 may include a first arm and a second arm defining a space between the first arm and the second arm. The cover connection portion 181 may be configured to receive the body connection portions 183 in the space between the first arm and the second arm, such that the body connection portion 183 is sandwiched between first arm and the second arm of the cover connection portion 181 forming a knuckle joint.

In some embodiments, the hinges 179 may prevent the lid 110 from traveling (e.g., rotating about the pivot points 185) beyond a desirable stopping position. For example, one or more of the cover connection portion 181 and the body connection portion 183 may include a stop 914. In some embodiments, the stop 169 may be configured to contact a portion of the lid 110 or the cooking portion assembly 104 of the grill device 100 when the lid 110 is at the desirable stopping position and may prevent the lid 110 further movement in a given direction. For example, in some embodiments, the stop 169 may prevent the lid 110 from opening beyond a certain point. In additional embodiments, the stop 169 may prevent the lid 110 from closing beyond a certain point. In some embodiments, the stop 169 may be configured to contact the opposing cover connection portion 181 or body connection portion 183 at the desirable stopping position.

In some embodiments, the hinges 179 may extend a distance away from an outer surface of the body of the grill device 100. In some embodiments, the lid 110 may include a lift assist mechanism. For example, the hinges 179 may include a spring, such as a torsion spring, configured to reduce the force required to lift the lid 110 from a closed position. In some embodiments, the hinges 179 may include a spring configured to reduce the force required to lift the lid 110 from a fully open position. In some embodiments, a single spring may be positioned such that the spring may assist in both directions. For example, the resting position of the spring may be a point substantially in the middle of the travel of the lid 110, such as when the cover is substantially fifty percent open. In some embodiments, the lift assist mechanism may include a counter weight. The counter weight may be coupled to the lid 110 in a manner that the weight of the counter weight may at least partially reduce the perceived weight of the lid 110. For example, the counter weight may be coupled to the lid 110 at a location where a downward force of the counter weight may generate a rotational force (e.g., moment, torque, etc.) on the lid 110 in the opening direction, such that the force required to open the lid 110 by the user is reduced. In some embodiments, the counter weight may be coupled to the lid 110 through a pulley connection. In some embodiments, the pulley connection may be configured to change a direction of the force from the counter weight. For example, the pulley connection may enable the counter weight to provide lift assistance from both a fully closed position and a fully open position. In some embodiments, the pulley connection may be configured as a force multiplier, such that the lift assistance provided by the counter weight may be greater than or less than the weight of the counter weight.

The lid 110 may have a general cylindrical shape, such as a half oval cylinder shape or a half cylinder shape. Furthermore, sidewalls of the lid 110 may have half oval shapes or half circle shapes. In some embodiments, the cylindrical shape may increase a rigidity of the lid 110, such as a rigidity of the lid 110 at or near the hinges 179. In some embodiments, the cylindrical shape may increase a strength of the lid 110 under loads, such as snow loads and other environmental factors. In some embodiments, the circular shape of the lid 110 may be configured to generate desirable airflow properties within the cooking chamber 130.

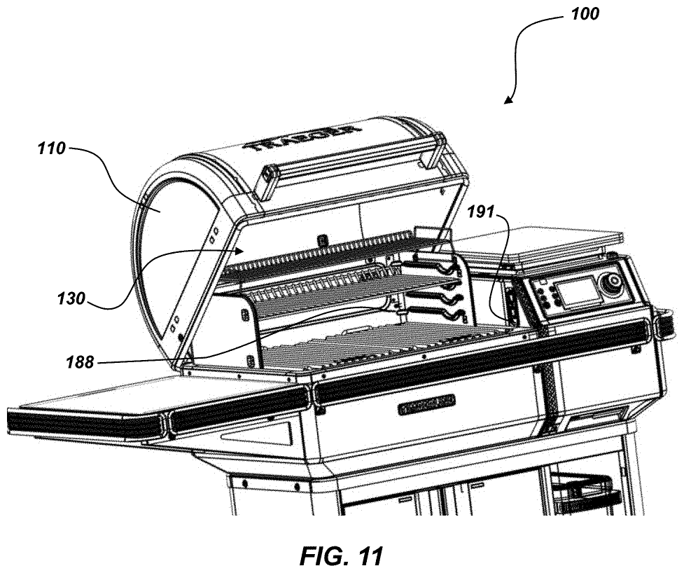

FIG. 11 is a front cross-sectional view of the grill device 100 according to one or more embodiments of the present disclosure. In some embodiments, the lid 110 may include a lid sensor 191 configured to determine if the lid 110 is open and/or if the lid 110 is closed. The lid sensor 191 may be operably coupled to the controller 106 and may provide information to the controller 106 regarding a state of the lid 110 (e.g., whether the lid 110 is open or closed). In some embodiments, the controller 106 may monitor the lid sensor 191 when the grill device 100 is active and generate an alarm to the user if the lid 110 is opened for an extended period of time while the grill device 100 is active. In some embodiments, the controller 106 may adjust an operation of the grill device 100 if the lid 110 is opened, as is described in greater detail below. In some embodiments, the lid sensor 191 may be configured to determine an amount by which the lid 110 is open. For example, the lid sensor 191 may measure an open percentage of the lid 110. In some embodiments, the lid sensor 191 may measure the open percentage of the lid 110 in steps, such as steps of 10%, steps of 5%, etc. In some embodiments, the lid sensor 191 may be a contact sensor, such as a contact switch, magnetic switch, optical switch, etc. In some embodiments, the lid sensor 191, may be a resistance based sensor, such as a potentiometer. In some embodiments, the lid sensor 191 may be an optical sensor such as a photoelectric distance sensor, a rotary encoder, etc. In some embodiments, the lid sensor 191 may be a magnetic sensor, such as a Hall Effect sensor configured to detect the presence of a magnet coupled to the lid 110 or even to detect a presence of the material of the lid 110 if the material of the lid 110 is ferromagnetic.

In some embodiments, the grill device 100 may include a temperature sensor 188 in the cooking chamber 130. The temperature sensor 188 may be operably coupled to the controller 106 of the grill device 100. The temperature sensor 188 may be configured to sense temperature information and provide the temperature information to the controller 106. In some embodiments, the temperature sensor 188 may include any conventional temperature sensor. In other embodiments, the temperature sensor 188 may include a ganged thermocouple (e.g., a multi-junction thermocouple). For example, the temperature sensor 188 may include a thermocouple having multiple junctions (e.g., welds) along a length of the thermocouple. For instance, the thermocouple may include two dissimilar thermo-element materials having a plurality of points where the two dissimilar thermo-element materials intersect. Each of the plurality of points may include an independent sensing point. In some embodiments, each of the plurality of points may include a spot-weld junction. In some embodiments, the thermocouple may at least substantially span a length of the grill device 100. As result, the thermocouple may enable measuring multiple temperatures throughout the grill device 100 with a single sensor. Therefore, by measuring temperatures throughout the grill device 100, the ganged thermocouple may provide more accurate averaged temperatures within the grill device 100. In further embodiments, the temperature sensor 188 may include any conventional temperature sensor. In some embodiments, the temperature sensor 188 may include multiple temperature sensors.

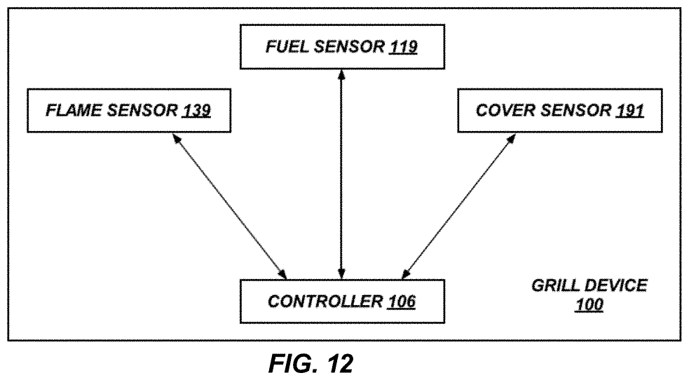

FIG. 12 is a schematic representation of portions of the grill device 100 according to one or more embodiments of the present disclosure. As depicted in FIG. 12, the controller 106 may be operably connected to the lid sensor 191, the fuel sensor 119, and the flame sensor 139. In some embodiments, the lid sensor 191, the fuel sensor 119, and the flame sensor 139 may be in wired communication with the controller 106. In other embodiments, the lid sensor 191, the fuel sensor 119, and the flame sensor 139 may be in wireless communication with the controller 106. For instance, the lid sensor 191, the fuel sensor 119, and the flame sensor 139 may communicate with the controller 106 via any of the wireless communication protocols described herein and/or any conventional wireless communication protocols.

During operation of the grill device 100, the controller 106 may utilize information received from the lid sensor 191, the fuel sensor 119, and/or the flame sensor 139 to optimize the operation of the grill device 100. For example, the grill device 100 may effectuate smart combustion of fuel within the fire pot assembly 120 utilizing information received from the lid sensor 191, the fuel sensor 119, and/or the flame sensor 139. For instance, the grill device 100 utilize information received from the lid sensor 191, the fuel sensor 119, and the flame sensor 139 to adjust and control combustion of fuel (e.g., wood pellets) within the fire pot assembly 120.

As a non-limiting example, the controller 106 may receive an indication from the lid sensor 191 that the lid 110 of the grill device 100 is open. In response to receiving an indication that the lid 110 of the grill device 100 is open, the controller 106 may adjust a fuel feed rate (e.g., wood-pellet feed rate) into the fire pot assembly 120. For example, the controller 106 may increase or decrease a rate at which the motor 173 turns the auger shaft 168 to feed fuel into the fire pot assembly 120. Furthermore, the controller 106 may verify an increased or decreased fuel feed rate via information received from the fuel sensor 119. In some embodiments, the controller 106 may continually adjust the rate at which the motor 173 turns the auger shaft 168 to achieve a desired fuel feed rate when the lid 110 is open. In one or more embodiments, the controller 106 may adjust the fuel feed rate in an effort to maintain and/or achieve a cooking characteristic (e.g., an internal temperature, a change in internal temperature, a smoke density, a smoke clarity, a smoke amount, etc.) of the grill device 100. For instance, the controller 106 may increase the fuel feed rate in response to receiving an indication that the lid 110 of the grill device 100 is open. In one or more embodiments, an amount at which the fuel feed rate is increased may be based on a current internal temperature of the grill device 100. In some embodiments, the longer the lid 110 is open and the internal temperature of the grill device 100 decreases, the more the fuel feed rate may be increased. In one or more embodiments, an amount by which the fuel feed rate is adjusted may be at least partially based on a differential temperature between an internal temperature of the grill device 100 and an environment temperature. In additional embodiments, the controller 106 may adjust the fuel feed rate to avoid wasting fuel while the lid 110 is open. For instance, the controller 106 may decrease the fuel feed rate in response to receiving an indication that the lid 110 of the grill device 100 is open.

In one or more embodiments, an amount by which a fuel rate is adjusted in response an indication that the lid 110 of the grill device 100 is open may be at least partially based on an amount by which the lid 110 is open. For example, if the lid 110 is fully open, an adjustment may be more drastic than if the lid 110 is only partially open.

Similarly, the controller 106 may receive an indication from the lid sensor 191 that the lid 110 of the grill device 100 is closed or recently closed. In response to receiving an indication that the lid 110 of the grill device 100 is closed, the controller 106 may adjust a fuel feed rate (e.g., wood-pellet feed rate) into the fire pot assembly 120. For example, the controller 106 may increase or decrease a rate at which the motor 173 turns the auger shaft 168 to feed fuel into the fire pot assembly 120. Furthermore, the controller 106 may verify an increased or decreased fuel feed rate via information received from the fuel sensor 119. In some embodiments, the controller 106 may continually adjust the rate at which the motor 173 turns the auger shaft 168 to achieve a desired fuel feed rate when the lid 110 is closed. In one or more embodiments, the controller 106 may adjust the fuel feed rate in an effort to maintain and/or achieve a cooking characteristic (e.g., an internal temperature, a change in internal temperature, a smoke density, a smoke clarity, a smoke amount, etc.) of the grill device 100. For instance, the controller 106 may increase the fuel feed rate in response to receiving an indication that the lid 110 of the grill device 100 is closed. In one or more embodiments, an amount at which the fuel feed rate is increased may be based on a current internal temperature of the grill device 100.

As another non-limiting example, the controller 106 may receive an indication from the flame sensor 139 that flames are present in the fire pot assembly 120. In response to receiving an indication from the flame sensor 139 that flames are present in the fire pot assembly 120, the controller 106 may adjust a fuel feed rate (e.g., wood-pellet feed rate) or airflow (e.g., fan speed) into the fire pot assembly 120. For example, the controller 106 may decrease or increase a fuel feed rate relative to a current fuel feed rate. For instance, during a startup process, the controller 106 may increase a fuel feed rate once flames are detected in the fire pot assembly 120, and an amount of the increase may at least partially depend on a desired temperature and a current internal or external temperature of the grill device 100. In other embodiments, the controller 106 may decrease a fuel feed rate when flames are detected in the fire pot assembly 120.

In one or more embodiments, the fuel feed rate may be adjusted based on a flame size, a flame color, flame intensity, or a temperature of a flame within the fire pot assembly 120. For instance, the flame sensor 139, or the flame sensor 139 in combination with a temperature sensor (e.g., temperature sensor 188), may provide flame data to the controller 106. As a non-limiting example, based on one or more of the flame size, the flame color, or the temperature of the flame in the fire pot assembly 120, the controller 106 may adjust a fuel feed rate to achieve and/or maintain a desired internal temperature (e.g., cooking temperature) of the grill device 100. The fuel feed rate and adjusted fuel feed rate may be monitored and determined via the fuel sensor 119 via any of the manners described above.

Additionally, the controller 106 may further control and adjust operation of the igniter 138 (e.g., ignition timing) and internal fans (e.g., pressurization fans, etc.) within the grill device 100 based on information received from one or more of the flame sensor 139, the fuel sensor 119, and the lid sensor 191.

In view of the foregoing, by effectuating an informed (i.e., smart) combustion utilizing information acquired from the flame sensor 139, the fuel sensor 119, and/or the lid sensor 191, the controller 106 may better control heat output by the fire pot assembly 120 over time. For instance, the controller 106 may better control the Btu/hr. of the grill device 100 in comparison to conventional grills. For example, the controller 106 may reduce a likelihood of an overshoot (e.g., feeding too many pellets into the fire pot assembly and increasing an internal temperature too much). The controller 106 may improve temperature recovery in the cooking chamber 130 after the lid 110 is opened. The controller 106 may also substantially prevent overfire conditions, decrease ignition time, improve temperature reliability, and enable further data collection. In some embodiments, the controller 106 may enable the grill device 100 to utilize additional features such as relatively cold smoke (e.g., lower temperature higher smoke cooking sequences) or variable smoke (e.g., controlling specific aspects of smoke production for changes to flavor, cooking properties, etc., of the smoke). Additionally, byproduct production may be reduced by improving combustion within the fire pot assembly. The controller 106 is discussed in greater detail in regard to FIG. 19.

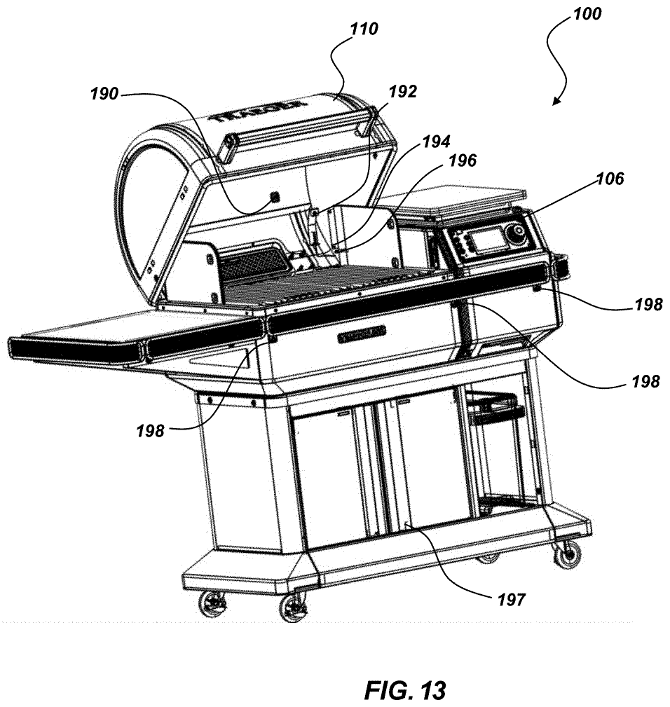

FIG. 13 is a perspective view of the grill device 100 according to one or more embodiments of the present disclosure. In some embodiments, the grill device 100 may further include a smoke sensor 190. The smoke sensor 190 may be operably coupled to the controller 106 and may provide information related to smoke production to the controller 106. In one or more embodiments, the smoke sensor 190 may be disposed in the cooking chamber 130 of the grill device 100. In other embodiments, the smoke sensor 190 may be disposed at an exhaust of the grill device 100. In further embodiments, the smoke sensor 190 may be disposed in the expansion chamber 132 of the grill device 100 above the fire pot assembly 120.

In one or more embodiments, the smoke sensor 190 may include a smoke color sensor and/or a smoke density sensor. For example, the smoke sensor 190 may include one or more optical sensors for determining smoke color. Additionally, the smoke sensor 190 may include one or more of an MQ-2 sensor or opacity meters for detecting smoke density and/or gas detectors or particulate detectors as described in further detail below.

In some embodiments, the controller 106 may utilize information acquired from the smoke sensor 190 (e.g., smoke color and/or density) to further inform smart combustion as described above in regard to FIG. 11. For example, the controller 106 may utilize information acquired from the smoke sensor 190 to customize combustion within the fire pot assembly 120 to achieve a desired smoke profile. For instance, the controller 106 may adjust combustion within the fire pot assembly 120 via any of the manners described herein to achieve a smoke profile to match a selectable flavor profile, a variable smoke profile, a low impact mode, or any other smoke profile within the grill device 100.

In yet further embodiments, the grill device 100 may include a gas detection sensors 192, volatile organic compound (VOC) sensors 194, and/or particulate matter (PM) sensors 196. Each of the gas detection sensors 192, the VOC sensors 194, and/or the PM sensors 196 may be operably coupled to the controller 106 and may provide information related to internal conditions of the grill device 100 to the controller 106. In one or more embodiments, one or more of the gas detection sensors 192, the VOC sensors 194, and/or the PM sensors 196 may be disposed in the cooking chamber 130 of the grill device 100. In other embodiments, one or more of the gas detection sensors 192, the VOC sensors 194, and/or the PM sensors 196 may be disposed at an exhaust of the grill device 100. In further embodiments, one or more of the gas detection sensors 192, the VOC sensors 194, and/or the PM sensors 196 may be disposed in the expansion chamber 132 of the grill device 100 above the fire pot assembly 120.

In some embodiments, the controller 106 may utilize information acquired from the gas detection sensors 192, the VOC sensors 194, and/or the PM sensors 196 to further inform smart combustion within the fire pot assembly 120, as described above in regard to FIG. 12. For example, the controller 106 may utilize information acquired from the gas detection sensors 192, the VOC sensors 194, and/or the PM sensors 196 to enable smoke ring adjustability, sense low level combustion within the fire pot assembly, monitor particulate matter generation, control particulate matter generation, and/or select combustion profiles based on a desired cooking (e.g., flavor) profile.

Referring still to FIG. 13, in some embodiments, the grill device 100 may include one or more proximity sensors 198 disposed proximate or on an exterior of the grill device 100. In some embodiments, the proximity sensor 198 may be operably coupled to the controller 106 and may provide information related to sensed object near (e.g., proximate) the grill device 100 to the controller 106. In some embodiments, the grill device 100 may include a single proximity sensor 198 near a rear (e.g., a back) of the grill device 100. In other embodiments, the grill device 100 may include a proximity sensor 198 for each side of the grill device 100.

In one or more embodiments, the one or more proximity sensors 198 may detect a presence of nearby objects to the grill device 100 without requiring physical contact. For example, the one or more proximity sensors 198 may emit an electromagnetic field or a beam of electromagnetic radiation (e.g., infrared radiation), and the one or more proximity sensors 198 may detect changes in the magnetic field or return signals. In some embodiments, the proximity sensor 198 may include one or more capacitive proximity sensors, photoelectric sensors, inductive proximity sensors, magnetic sensors, optical sensors, Hall Effect sensors, or any other conventional proximity sensors, etc.

In some embodiments, the proximity sensor 198 may provide information to the controller 106 regarding whether or not the grill device 100 is proximate to other objects (e.g., a building, structure, etc.) and a distance between the grill device 100 and the other objects.

Furthermore, the controller 106 may adjust operation of the grill device based on whether or not the grill device 100 is too proximate (e.g., too close) to another object. For example, when the grill device 100 is too close to another object, the controller 106 may cause the grill device 100 to reduce an operating temperature or to shut down completely. Furthermore, in some embodiments, the controller 106 may prevent ignition of the grill device 100 when the grill device 100 is too close to another object. Moreover, in some embodiments, the controller 106 may permit the grill device 100 to be remotely started (i.e., ignited) via a remote device (e.g., a mobile device), such as any of the remote devices referred to in regard to FIG. 1, when the proximity sensor 198 does not detect objects too close to the grill device 100.

Because the controller 106 may adjust and/or control operation of the grill device 100 based at least partially on information received from the proximity sensor 198, the proximity sensor 198 may assist in reducing risk of fires and or damage caused by the grill device 100 being too close to other objects during operation.

In some embodiments, the grill device 100 may also include a cover opener sensor 197 and one or more motors or solenoids for opening the lid 110 of the grill device 100. The cover opener sensor 197 may be operably coupled to the controller 106 and may provide information as to a detection of a motion or an object near the cover opener sensor 197. For instance, the cover opener sensor 197 may be disposed beneath the base assembly 102 of the grill device 100 and may detect a presence (e.g., a new presence) of an object and/or motion beneath the grill device 100. As a non-limiting example, the cover opener sensor 197 may be configured to detect a presence or motion of a foot beneath the base assembly 102 of the grill device 100. In response to receiving an indication from the cover opener sensor 197, the controller 106 may cause the lid 110 of the grill device 100 to open via the one or more motors and/or solenoids of the grill device 100.

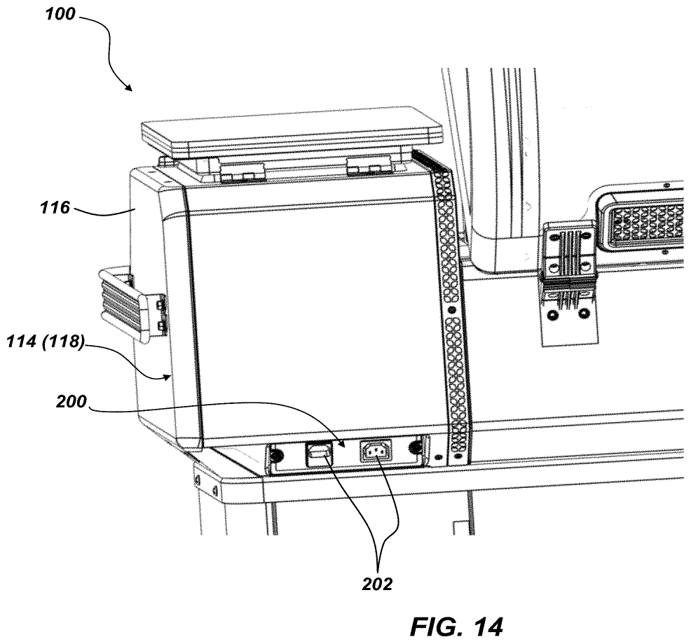

FIG. 14 is a rear partial perspective view of the grill device 100 according to one or more embodiments of the present disclosure. In some embodiments, the grill device 100 may include a power strip 200 including one or more sockets 202 for receiving a correlating plug or connector and for providing power and/or transferring (e.g., providing and/or receiving) data through the one or more sockets 202. In one or more embodiments, the power strip 200 may form a portion of the fuel chamber 114 (i.e., the hopper 118). In some embodiments, the one or more sockets 202 may include one or more of 120V or 240V Type A and/or B sockets, USB Type A sockets, mini-USB sockets, micro-USB sockets, USB-C sockets, lightning sockets (iPhone), or any other type of power providing or data transferring socket.

Furthermore, the power strip 200 and its associated sockets 202 may be operably coupled to the controller 106 of the grill device 100. In some embodiments, the sockets 202 may be utilized to operably couple grill accessories (e.g., temperature probes, additional cooking ovens, etc.) to the controller 106 and/or to power grill accessories. Moreover, the sockets 202 may be utilized to power any other devices (e.g., charge a phone).

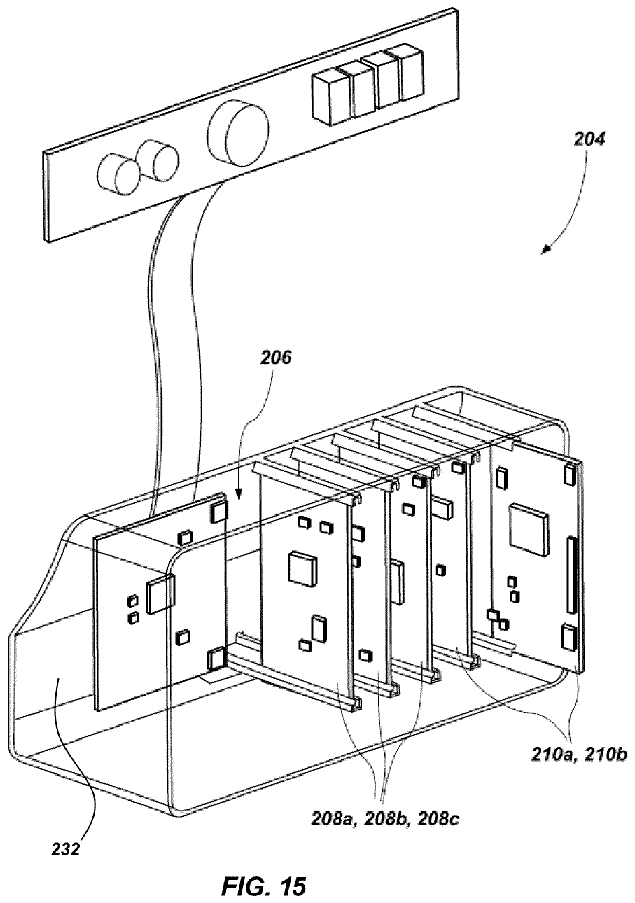

FIG. 15 is a perspective view of a modular printable circuit board 204 of the controller 106 of the grill device 100. In some embodiments, the modular printable circuit board 204 may include a single motherboard 206, one or more discrete feature boards 208a, 208b, 208c, one or more discrete user interface boards 210a, 210b, and a power bus 232.

In some embodiments, each of the motherboard 206, the discrete feature boards 208a-208c, and user interface boards 210a, 210b may include discrete microcontrollers (e.g., at least one processor and memory) for retrieving and executing instructions. In one or more embodiments, the motherboard 206 may be dedicated to (e.g., may execute and control) core functionalities of the grill device 100, and the one or more discrete feature boards 208a, 208b, 208c and one or more discrete user interface boards 210a, 210b may each be dedicated to (e.g., may execute and control) a respective feature and/or user interface. For example, in some embodiments, the motherboard 206 may control and operate one or more communication ports, at least one food probe, smart combustion (e.g., pellet sensing, flame sensing, cover sensing) within the fire pot assembly 120, AC input, etc., of the grill device 100. Additionally, the one or more discrete features boards 208a, 208b, 208c may be dedicated to controlling one or more of additional food probes, a rotisserie device, cellular capabilities, a solar battery charging and use, internet capabilities, additional burners, convection fans, speakers and microphones, cameras, retrieving and analyzing weather information, lighting, the power strip 200, additional accessories, etc., of the grill device 100. Furthermore, the one or more user interface boards 210a, 210b may operate and control user interfaces displayed on the display 111 of the controller 106.

Additionally, the one or more discrete feature boards 208a, 208b, 208c and the one or more discrete user interface boards 210a, 210b may be modular such that the boards can be removed from the motherboard 206 and/or easily and quickly replaced. For example, the motherboard 206 may include sufficient slots to receive a sufficient number of discrete feature boards 208a, 208b, 208c and the discrete user interface boards 210a, 210b to enable full functionality of all capabilities of the grill device 100.

Because the additional features beyond core functionalities of the grill device 100 are controlled via discrete and respective boards, the grill device 100 may be produced and sold with any level of functionality with full functionality being addable later. Accordingly, regardless of a level of the grill device 100 and the capabilities of the grill device 100 at the time of sale, the grill device 100 can be upgraded to include additional capabilities by adding boards to and/or replacing boards (e.g., feature and/or user interface boards) coupled to the motherboard 206. The foregoing permits a common motherboard 206 to be utilized throughout production of grill devices 100 regardless of whether the grill device is entry level (e.g., a less expensive option having fewer capabilities) or a premier level (e.g., a more expensive option including all capabilities). Furthermore, the common motherboard 206 permits the entry level grill device to be upgraded to the premier level grill device and/or be customized to fit a user's personal preferences by adding or replacing feature and user interface boards.

Referring still to FIG. 15, the modular printable circuit board 204 may provide the grill device 100 with advantages over conventional grills. For example, as noted above, unlike conventional grills, the capabilities of the grill device 100 may be added thereto and customized after purchase to fit a user preferences. Furthermore, because the motherboard 206 is common throughout different levels of the grill device 100, costs for producing multiple different motherboards for different levels of grill devices may be avoided. As a result, the common motherboard 206 may reduce a cost of production of controllers for the grill device 100 in comparison to conventional grills.

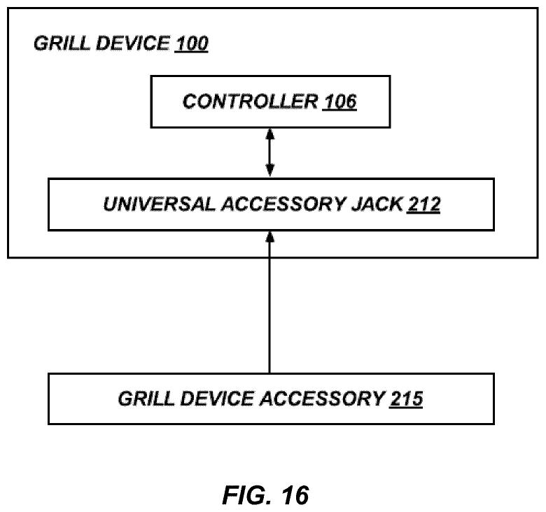

FIG. 16 is a schematic representation of portions of the grill device 100. In some embodiments, the grill device 100 may include a universal accessory jack 212 for receiving a connection from a grill device accessory 215. Furthermore, the universal accessory jack 212 may be operably coupled to the controller 106 of the grill device 100. The universal accessory jack 212 may be compatible with connections of at least temperature probes, additional ovens (e.g., a pizza oven), induction hobs, additional burners, rotisserie devices, any of the sensors described herein, skillets, thermostats, candy thermometers, tagines, etc.

In some embodiments, the grill device accessory 215 may be an induction hob 1800 as illustrated in FIG. 18C. The induction hob is described in further detail below. In some embodiments, the grill device accessory 215 may be a pizza oven. The pizza oven may be configured receive heat from the grill device 100, such as from a burner in the grilling device 100, smoke and/or heat from burning pellets, wood, and/or charcoal. In some embodiments, the pizza oven may include a heat source, such as a burner, electric heating element, heating chamber for burning pellets, wood, and/or charcoal, etc. In some embodiments, the pizza oven may include a temperature probe configured to detect a temperature inside the pizza oven. For example, the pizza oven may be configured to control the heat source to control a temperature inside the pizza oven. In some embodiments, the temperature inside the pizza oven may be controlled to a temperature between about 300 degrees F. (148.89 degrees C.) and about 900 degrees F. (482.22 degrees C.), such as between about 500 degrees F. (260 degrees C.) and about 800 degrees F. (426.67 degrees C.), or about 700 degrees F. (371.11 degrees C.).

The grill device accessory 215 may be coupled to the universal accessory jack 212. In some embodiments, the grill device accessory 215 may be coupled to an auxiliary housing 242. In some embodiments, the auxiliary housing 242 may include the universal accessory jack 212. In some embodiments, the auxiliary housing 242 may be located on a side of the grill device 100. For example, the auxiliary housing 242 may be a shelf on a side of the grill configured to support the grill device accessory 215.

In some embodiments, the controller 106 may be configured to determine a type of accessory connected to the universal accessory jack 212. In some embodiments, the controller 106 may be configured to determine the type of accessory based on a mechanical interference between the universal accessory jack 212 and a connector of the grill device accessory 215. In other embodiments, the controller 106 may be configured to determine the type based on information (e.g., signal) received from the grill device accessory 215 via the universal accessory jack 212 and/or information queried from the grill device accessory 215 via the universal accessory jack 212. In other embodiments, the controller 106 may be configured to determine the type of accessory based on an element in the connector of the grill device accessory 215, such as a resistor, a signal generator, an inductor, etc. In one or more embodiments, the controller 106 may also control and/or monitor operation of the grill device accessory 215.

In some embodiments, the controller 106 may control and/or adjust operation of the grill device 100 via any of the manners described herein based at least partially on the type of detected grill device accessory 215. For example, the controller 106 may adjust one or more of smoke generation, internal temperature, fuel feed rates, ignition timing, etc., based at least partially on the type of detected grill device accessory 215. Furthermore, in some embodiments, based on the type of detected grill device accessory 215, the controller 106 may present one or more options on the display 111 and/or on a remote device (e.g., remote device 103) related to functionality of the detected grill device accessory 215.

In some embodiments, the controller 106 may provide an indication of which grill device accessory 215 is connected to the universal accessory jack 212. In some embodiments, the controller may determine, which recipes may be used based on the connected grill device accessory 215.

In some embodiments, the controller 106 may adjust controls of the grill device 100 based on the grill device accessory. For example, an induction hob may enable the grill device 100 to be operated at a lower temperature because the food may be seared at a high temperature on the induction hob. In some embodiments, the controller may operate the grill device 100 at a higher temperature when a pizza oven is connected to raise a temperature of the grill device 100 to provide a higher temperature in the pizza oven.

In some embodiments, the controller 106 may provide instructions to the user based on the grill device accessory 215 connected to the universal accessory jack 212, such a timers, temperature settings, etc., for performing common tasks with the specific grill device accessory. For example, the controller may provide searing times and temperatures to a user if the induction hob is connected to the universal accessory jack 212. In some embodiments, different menus may be available to the user based on the type of grill device accessory 215. For example, menus directed toward grill items that need to be seared may be available if the induction hob is connected and menus directed toward pizza may be available if the pizza oven is connected.

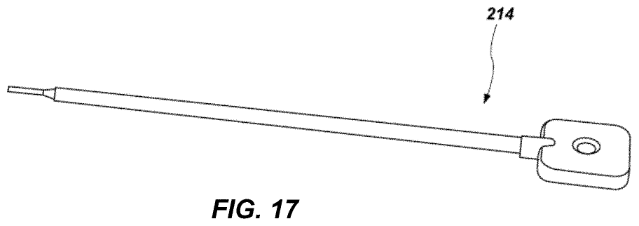

FIG. 17 is a perspective view of a wireless temperature probe 214 according to one or more embodiments of the present disclosure. In one or more embodiments, the wireless temperature probe 214 may be operably coupled to the controller 106 via wireless communication. For example, the wireless temperature probe 214 may communicate with the controller 106 via Bluetooth (BTE) or any other wireless communication protocol. In one or more embodiments, the wireless temperature probe 214 may also communicate directly with a remote device (e.g., a remote device 103).

The wireless temperature probe 214 may include a power source. In some embodiments, the power source may be disposed at a longitudinal end of the wireless temperature probe 214 opposite a tip of the wireless temperature probe 214 intended to be inserted into a food product being prepared with the grill device 100. In one or more embodiments, the power source may include a battery. In other embodiments, the power source may include a capacitive energy storage device. In additional embodiments, the power source may include a thermoelectric cooling energy conversion device.

In one or more embodiments, the power source of the wireless temperature probe 214 may be at least partially wirelessly charged. For example, the power source of the wireless temperature probe 214 may be chargeable via electromagnetic induction. In one or more embodiments, the power source of the wireless temperature probe 214 may be chargeable on the grill device 100. In particular, the wireless temperature probe 214 may include a receiver coil, and the grill device 100 may include a transmitter coil. Furthermore, the receiver coil and transmitter coil may operate via conventional methods to charge the power source of the wireless temperature probe 214.

In some embodiments, at least a portion of the wireless temperature probe 214 may include stainless steel, polyoxybenzylmethylenglycolanhydride (e.g., BAKELITE®), silicone, polytetrafluoroethylene (e.g., PTFE, TEFLON®, RULON®, etc.), ceramic, enamels, aluminum, etc.

In one or more embodiments, the wireless temperature probe 214 may include a resistance temperature detector, such as a negative temperature coefficient thermistor (NTC thermistor), positive temperature coefficient thermistor (PTC thermistor), or resistance temperature detectors (RTD). For example, the wireless temperature probe 214 may include a length of wire (e.g., platinum wire, nickel wire, copper wire, etc.) wrapped around a ceramic or glass core disposed within a housing (e.g., a tube of the wireless temperature probe 214). As a temperature increases around the wireless temperature probe 214, the resistance in the length of wire may increase in substantially linear manner such that the temperature may be measured through the change in resistance of the wireless temperature probe 214. Furthermore, the resistance temperature detector may operate via conventional methods. In some embodiments, the wireless temperature probe 214 may include a thermocouple or other sensor configured for measuring a temperature.

In some embodiments, the wireless temperature probe 214 may be wirelessly powered. For example, the wireless temperature probe 214 may be powered through radio frequency (RF) transmitted power, thermal energy harvesting (e.g., thermoelectric cooler (TEC), thermoelectric generators (TEG), thermopiles, thermocouples, etc.), or solar power. In some embodiments, the wireless temperature probe 214 may be battery powered. The wireless temperature probe 214 may be configured to wirelessly charge the battery, such as through a conventional inductive charging system. In other embodiments, the wireless temperature probe 214 may be configured to charge the battery through any one of above mentioned wireless power sources. In some embodiments, the wireless temperature probe 214 may have alternative power storage, such as capacitive power storage, which may be powered and/or charged through any of the above methods.

FIG. 18A is a rear view of the grill device 100 according to one or more embodiments of the present disclosure. In some embodiments, the grill device 100 may include an exhaust port 216 formed in the lid 110 of the grill device 100. As will be understood by one of ordinary skill in the art, during operation, smoke and other byproducts of combustion and cooking processes occurring within the grill device 100 may escape from the cooking chamber 130 of the grill device 100 through the exhaust port 216.

In one or more embodiments, the grill device 100 may further include a filter 218 configured to capture particulate from the smoke prior to the smoke escaping to the atmosphere. In some embodiments, the filter 218 may include a water filtration system (e.g., a water pipe). In additional embodiments, the filter 218 may include a High Efficiency Particulate Air (HEPA) filter. In further embodiments, the filter 218 may include a catalytic converter system for catalyzing a redox reaction (an oxidation and a reduction reaction) to reduce toxic gases and pollutants in the exhaust smoke.

In some embodiments, as noted above, the grilling device 100 may include an induction hob 1800 accessory coupled to a side of the grilling device 100. For example, the induction hob 1800 may be secured into a shelf 1802 of the grilling device 100 (FIG. 18B). The induction hob 1800 may be configured to act as a searing station. A searing station may be configured to provide a high temperature surface configured to sear an outer portion of a food item to be cooked, such as a steak, a hamburger, chicken breast, etc. For example, the induction hob 1800 may include an induction coil configured to heat a searing plate 1804. The induction coil may be configured to excite electrons in the searing plate 1804. The excited electrons in the searing plate 1804 may cause a temperature of the searing plate 1804 to increase. The induction coil may cause the temperature of the searing plate 1804 to rise to a temperature between about 300 degrees F. (148.89 degrees C.) and about 800 degrees F. (426.67 degrees C.), such as about 750 degrees F. (398.89 degrees C.).

In some embodiments, the searing plate 1804 may be a pot, a pan, a plate, etc. For example, the searing plate 1804 may be a pot having a base and sides. In some embodiments, the searing plate 1804 may be substantially circular. For example, the searing plate 1804 may be a pot that is substantially cylindrical having a substantially circular base and sides extending from the circular base forming a cylinder. In some embodiments, the searing plate 1804 may include a base having another common shape such as, an oval, a square, a rectangle, a triangle, etc.

In some embodiments, spacers 1806 may be positioned between the searing plate 1804 and the induction hob 1800. For example, the searing plate 1804 may include one or more spacers 1806 protruding from a bottom surface 1808 of the searing plate 1804 such that when the searing plate 1804 rests over the induction hob 1800 an air gap 1810 is formed between the induction hob 1800 and the searing plate 1804. In other embodiments, the one or more spacers 1806 may protrude from a top surface 1812 of the induction hob 1800 such that the bottom surface 1808 of the searing plate 1804 may rest on the spacers 1806 forming the air gap 1810 between the induction hob 1800 and the searing plate 1804. The air gap 1810 may enable the induction coil to raise the temperature of the searing plate 1804 to a high temperature by exciting electrons in the searing plate 1804 while maintaining a substantially lower temperature on the surface of the induction hob 1800. Reducing the temperature of the induction hob 1800 may reduce the potential for temperature damage to the more delicate induction coil, such as melted coils, welded coils, shorts within the coils, etc. The induction coil may continue to excite the electrons in the searing plate 1804 across the air gap 1810, thus maintaining high searing temperatures in the more robust searing plate 1804.

As illustrated in FIG. 18A, the induction hob 1800 accessory may be positioned on an opposite side of the grilling device 100 from the hopper 118. For example, the fuel storage chamber 114 or hopper 118 may be positioned on a first side of the cooking chamber 130 and the induction hob 1800 accessory may be positioned on a second opposite side of the cooking chamber 130.

FIG. 18B illustrates a top view of the shelf 1802. The shelf 1802 may include an aperture 1814 configured to receive the induction hob 1800. The shelf 1802 may include indexing structures 1816, such as tabs, keys, fingers, ridges, etc., configured to interface with a side surface of the induction hob 1800 to locate the induction hob 1800 within the aperture 1814 in the shelf 1802. The shelf 1802 may include a lower shelf surface 1818 configured to prevent the induction hob 1800 from passing completely through the shelf 1802. For example, the lower shelf surface 1818 may extend into the aperture 1814 by a greater amount than a top shelf surface 1820, such that a lower surface of the induction hob 1800 may rest on the lower shelf surface 1818.

FIG. 18C illustrates the induction hob 1800 separate from the grilling device 100. The induction hob 1800 may include complementary features 1822 in the side surfaces of the induction hob 1800. The complementary features 1822 may be configured to receive the indexing structures 1816 of the shelf 1802. The side surfaces of the induction hob 1800 may have a substantially complementary shape to the shape of the aperture 1814 of the shelf 1802. In some embodiments, the top surface 1812 of the induction hob 1800 may be larger than the aperture 1814 in the shelf 1802, such that a bottom portion of the top of the induction hob 1800 may rest on the top shelf surface 1820 of the shelf 1802. In other embodiments, the top surface 1812 of the induction hob 1800 may be sized such that the top surface 1812 of the induction hob 1800 may be disposed into the aperture 1814 until the top surface 1812 of the induction hob 1800 is substantially co-planar with the top shelf surface 1820 of the shelf 1802. For example, a bottom surface 1824 of the induction hob 1800 may be configured to rest on the lower shelf surface 1818 and the induction hob 1800 may have a thickness substantially the same as the shelf 1802, such that the top surface 1812 of the induction hob 1800 is at substantially the same height as the top shelf surface 1820.

The induction hob 1800 may include a control input 1826 extending from the top surface 1812 of the induction hob 1800. In some embodiments, the control input 1826 may be a single input. For example, the control input 1826 may be a button, such as an on/off button, auto/manual button, etc. In another example, the control input 1826 may be a twist knob, such as a temperature set point dial, a mode selection dial, etc. In other embodiments, the control input 1826 may be a multifunctional input. For example, the control input 1826 may include a push button, a twist knob, and/or a joy stick. In some embodiments, the control input 1826 may interface with a display, such as the display 111 of the grill device 100.

The induction hob 1800 may include one or more sensors 1828. For example, the induction hob 1800 may include a sensor 1828 in the top surface 1812 of the induction hob 1800. In some embodiments, the sensor 1828 may be a temperature sensor configured to detect a temperature of the searing plate 1804. In other embodiments, the sensor 1828 may be a sensor configured to detect a presence of the searing plate 1804, such as a proximity sensor, Hall Effect sensor, light sensor, etc.

The induction hob 1800, the control input 1826, and/or the one or more sensors 1828 may be coupled to the controller 106 of the grill device 100 through an electrical connection 1830. The electrical connection 1830 may provide power to the induction hob 1800 from the grill device 100. In some embodiments, the electrical connection 1830 may enable signals to pass between the induction hob 1800 and the grill device 100, such as control signals, sensor readings, status signals, fault signals, etc. For example, the electrical connection 1830 may be a communication interface. In other embodiments, the induction hob 1800 may be configured to communicate with the controller 106 of the grill wirelessly, such that the electrical connection may provide power to the induction hob 1800 and the signal may pass between the induction hob 1800 and the grill device 100 wirelessly, such as through radio signals (e.g., Bluetooth, etc.).

In some embodiments, the controller 106 may be configured to automatically turn on the induction hob 1800 and/or to set a temperature set point for the induction hob 1800. For example, the induction hob 1800 may be configured to sear the item being cooked. A custom cooking cycle may define a specified time during the cooking cycle, such as the end of the cooking cycle, the beginning of the cooking cycle, etc., when the item being cooked should be placed on the searing plate 1804. The controller 106 may send a signal to the induction hob 1800 to turn on and heat the searing plate 1804 to the desired temperature, such that when the cooking cycle reaches the specified time for searing the item being cooked, the item being cooked may be moved to the searing plate 1804 that may be at the searing temperature.

The grill device 100 may be configured to communicate with the user, such as through alerts presented at the grill device 100 (e.g., sounds, displays, lights, etc.) or alerts displayed at a remote device (e.g., a mobile device, cell phone, smart phone, tablet, etc.). For example, the grill device 100 may alert the user when the searing plate 1804 is at a specific temperature, when cooking cycle reaches a specified time/temperature to move the item being cooked to the searing plate 1804, when the item being cooked should be turned or rotated on the searing plate 1804, when the item being cooked should be removed from the searing plate 1804, etc. When the searing time is completed, the controller 106 may send a signal to the induction hob 1800 to turn off the induction hob 1800 allowing the searing plate 1804 to cool. In some embodiments, the user may communicate with the grill device 100 through a user interface on the grill device 100 or in a remote device. For example, the user may activate or deactivate the induction hob 1800 through the user interface.

FIG. 19 illustrates a block diagram of an example controller 106 that may be configured to perform one or more of the processes described above. One will appreciate that one or more computing devices may form the controller 106 of the grill device 100. As shown by FIG. 19, the controller 106 can comprise a processor 222, a memory 224, a storage device 226, an I/O interface 228, and a communication interface 230, which may be communicatively coupled by way of a communication infrastructure. While an example controller 106 is shown in FIG. 19, the components illustrated in FIG. 19 are not intended to be limiting. Additional or alternative components may be used in other embodiments. Furthermore, in certain embodiments, the controller 106 can include fewer components than those shown in FIG. 19. Components of the controller 106 shown in FIG. 19 will now be described in additional detail.

In one or more embodiments, the processor 222 includes hardware for executing instructions, such as those making up a computer program. As an example, and not by way of limitation, to execute instructions, the processor 222 may retrieve (or fetch) the instructions from an internal register, an internal cache, the memory 224, or the storage device 226 and decode and execute them. In one or more embodiments, the processor 222 may include one or more internal caches for data, instructions, or addresses. As an example, and not by way of limitation, the processor 222 may include one or more instruction caches, one or more data caches, and one or more translation look aside buffers (TLBs). Instructions in the instruction caches may be copies of instructions in the memory 224 or the storage 606.

The controller 106 includes memory 224, which is coupled to the processor(s) 602. The memory 224 may be used for storing data, metadata, and programs for execution by the processor(s). The memory 224 may include one or more of volatile and non-volatile memories, such as Random-Access Memory (“RAM”), Read-Only Memory (“ROM”), a solid state disk (“SSD”), Flash, Phase Change Memory (“PCM”), or other types of data storage. The memory 224 may be internal or distributed memory.

The controller 106 includes a storage device 226 that includes storage for storing data or instructions. As an example, and not by way of limitation, storage device 226 can comprise a non-transitory storage medium described above. The storage device 226 may include a hard disk drive (HDD), a floppy disk drive, Flash memory, an optical disc, a magneto-optical disc, magnetic tape, or a Universal Serial Bus (USB) drive or a combination of two or more of these. The storage device 226 may include removable or non-removable (or fixed) media, where appropriate. The storage device 226 may be internal or external to the controller 106. In one or more embodiments, the storage device 226 is non-volatile, solid-state memory. In other embodiments, the storage device 226 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or Flash memory or a combination of two or more of these.

The controller 106 also includes one or more input or output (“I/O”) devices/interfaces 228 (e.g., a touch display), which are provided to allow a user to provide input to, receive output from, and otherwise transfer data to and receive data from controller 106. The I/O devices/interfaces 228 may include a mouse, a keypad or a keyboard, a touch screen, a camera, an optical scanner, network interface, modem, other known I/O devices or a combination of such I/O device/interfaces. The touch screen may be activated with a stylus or a finger.

The I/O devices/interfaces 228 may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 228 is configured to provide graphical data to a display for presentation to a user. The graphical data may be representative of one or more graphical user interfaces and/or any other graphical content as may serve a particular implementation.

The controller 106 can further include a communication interface 230. The communication interface 230 can include hardware, software, or both. The communication interface 230 can provide one or more interfaces for communication (such as, for example, packet-based communication) between the controller 106 and one or more other computing devices or networks. As an example, and not by way of limitation, the communication interface 230 may include a network interface controller (NIC) or network adapter for communicating with an Ethernet or other wire-based network or a wireless NIC (WNIC) or wireless adapter for communicating with a wireless network, such as a WI-FI and/or Bluetooth. The controller 106 can further include a bus 232. The bus 232 can comprise hardware, software, or both that couples components of controller 106 to each other.

The controller 106 may be configured to monitor each of the sensors within the grill device 100. The controller 106 may identify or diagnose problems and/or malfunctions of the grill device 100 based on readings of the sensors. For example, the controller 106 may determine if a sensor is returning an improper reading. The controller 106 may then determine possible causes of the improper reading. For example, the improper reading may be a faulty sensor or a failure of another mechanism or component related to the system being monitored by the sensor. The controller 106 may determine the possible causes of the improper reading by eliminating possible causes based on sensor readings near the improper sensor reading and from other associated systems. For example, if a temperature reading is low, the controller 106 may determine if there is flame by checking the flame sensor 139 and may determine if there is sufficient pellet flow by checking the various fuel sensors. Based on the other sensor readings, the controller may determine if the low temperature reading is a result of a faulty temperature sensor, a lack of fuel, or a failure in the flame system.

The controller 106 may be configured to notify the user of the problem. For example, the controller 106 may display a fault code on the display 111 or on a mobile device of the user. In some embodiments, the controller 106 may provide the user with additional information such as how to videos, part number information, links to purchase replacement parts, etc. In some cases, the additional information may be provided through one-dimensional (1D) code (e.g., a barcode) or a two-dimensional (2D) code (e.g., QR code). For example, the 1D code or 2D code may be displayed on the display 111 such that the user may scan the code with a mobile device and it may direct the user to a webpage or links to webpages including the additional information. In some embodiments, the code may be sent directly to the user's mobile device.

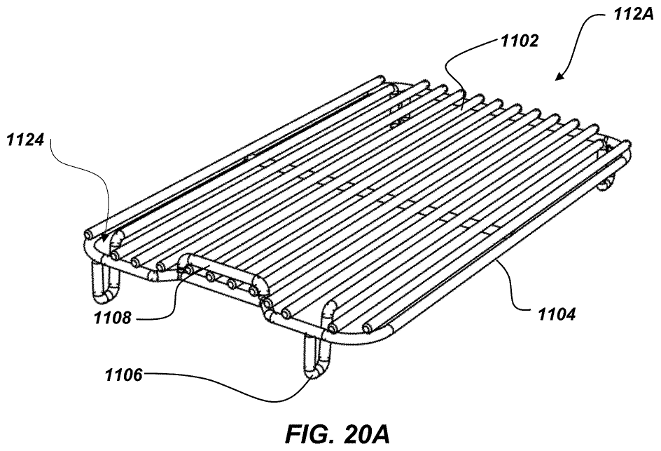

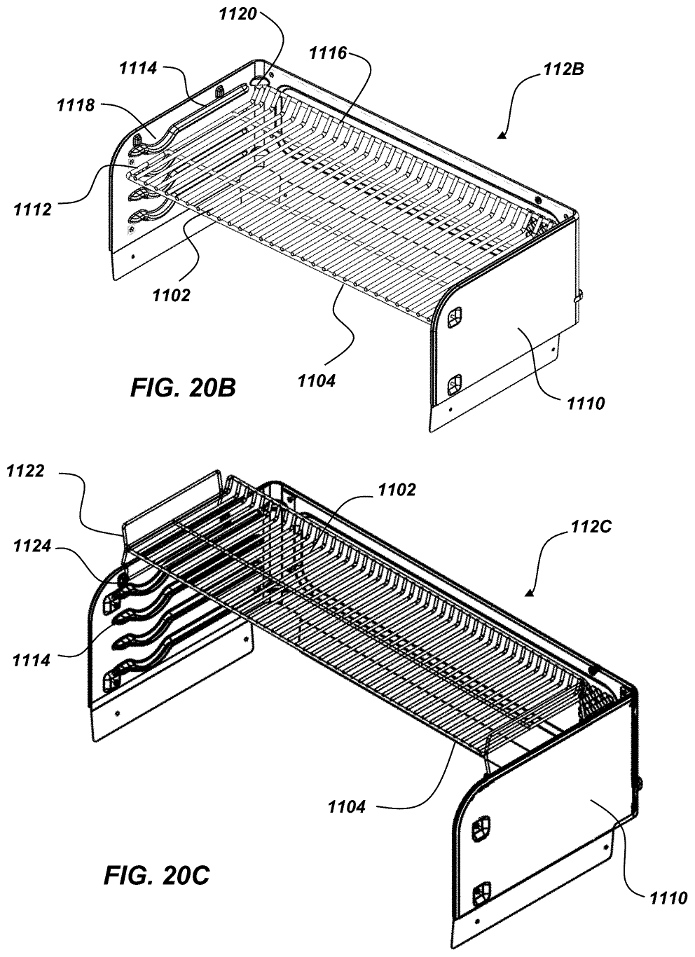

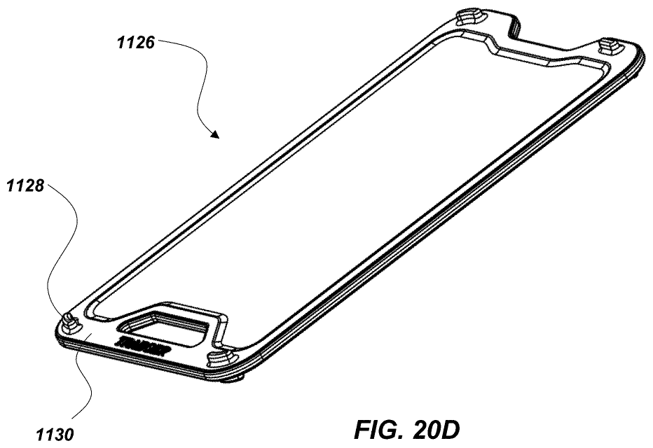

FIGS. 20A-20C illustrate embodiments of one or more of the grates 112 of the grill device 100. The grates 112 may include multiple surface rails 1102 that may combine to form a cooking surface. In some embodiments, the surface rails 1102 may be arrange in a substantially parallel configuration (e.g., such that each rail is substantially parallel to an adjacent rail). In some embodiments, the surface rails 1102 may be arranged in a substantially orthogonal configuration (e.g., such that each rail is substantially perpendicular to another rail). In some embodiments, the surface rails 1102 may be arranged in a radial arrangement (e.g., multiple annular rings arrange concentrically).

The surface rails 1102 may be arranged over one or more support rails 1104. The support rails 1104 may form a border extending along the outer edges of the surface rails 1102. In some embodiments, the support rails 1104 may be arranged such that at least a portion of the support rails 1104 is not parallel with the surface rails 1102. For example, the support rails 1104 may be coupled to multiple surface rails 1102 securing the multiple surface rails 1102 with respect to one another.

FIG. 20A illustrates an embodiment of a base grate 112A. The base grate 112A may include one or more feet 1106. The one or more feet 1106 may be configured to interface with a base in the cooking chamber 130. In some embodiments, the feet 1106 may be configured to space the base grate 112A from a heat source in the cooking chamber 130. For example, the feet 1106 may be configured to rest against a base or shelf above the heat source such that the surface rails 1102 are as far away from the heat source as the feet are tall. Spacing the surface rails 1102 from the heat source may improve heat distribution and/or airflow substantially reducing hot spots and cold spots at the surface rails 1102 to provide a substantially even heat at the cooking surface.

In some embodiments, the cooking chamber 130, may include a keyed surface. For example, the base or shelf configured to support the feet 1106 may include keying features configured to receive the feet 1106. The keying features may be configured to secure the base grate 112A relative to the base or shelf, such that the base grate 112A is secured both vertically and laterally (e.g., such that the base grate 112A is substantially prevented from moving downward relative to the base or shelf and substantially prevented from moving side to side, forward, or backward relative to the base or shelf). In some embodiments, the feet 1106 may enable a user to adjust a distance between the base grate 112A and a heat source (e.g., fire pot assembly 120). For example, the user may invert the base grate 112A (i.e., turn the base grate 112A upside down), such that the feet 1106 are facing upward away from the heat source. The distance between the base grate 112A and the heat source may be reduced by the height of the feet 1106 when the base grate 112A is placed in the cooking chamber 130 in the inverted orientation.

In some embodiments, the base grate 112A may include a nesting feature 1108. The nesting feature 1108 may be configured to secure a cooking accessory, such as pizza ovens, rotisserie devices, skillets, broilers, tagines, etc., relative to the base grate 112A. As illustrated in FIG. 20A, the nesting feature 1108 may be an annular ring formed in a portion of the support rail 1104. The nesting feature 1108 may be configured to receive a complementary element on the cooking accessory. For example, a cooking accessory may include a protruding member configured to pass through the annular ring, such that the protruding member may interlock with the nesting feature 1108. When the protruding member interlocks with the nesting feature 1108, the cooking accessory may be secured to the base grate 112A. When the cooking accessory is secured to the base grate 112A, the base grate 112A may then secure the cooking accessory within the cooking chamber 130.

In some embodiments, the base grate 112A may include a nesting feature, such as a recess configured to receive a protrusion or protruding element from a cooking accessory. For example, a space 1124 created in the base grate 112A, where each foot 1106 extends away from the base grate 112A may act as a nesting feature. A cooking accessory, such as the cooking accessory 1126 illustrated in FIG. 20D may include complementary nesting features 1128 extending from a base 1130 of the cooking accessory 1126. The complementary nesting features 1128 may be configured to be disposed into the space 1124 created in the base grate 112A by the feet 1106. The complementary nesting features 1128 may be configured to substantially limit movement of the cooking accessory 1126 when nested in the space 1124 in the base grate 112A, such that the 1126 may be substantially limited to vertical movement.

FIG. 20B illustrates an embodiment of an intermediate grate 112B. The grill device 1000 may include one or more support walls 1110 as illustrated in FIG. 20B. The support wall 1110 may be configured to support the 112B in a region of the cooking chamber 130 above the base grate 112A. For example, the intermediate grate 112B may include side rails 1112 configured to interface with one or more features on the support wall 1110. For example, the support wall 1110 may include one or more tracks 1114 configured to support the intermediate grate 112B through the side rails 1112. In some embodiments, the tracks 1114 may be ridges protruding from the support wall 1110 configured to support a bottom surface of the side rails 1112, such that the side rails 1112 slide along the ridges protruding from the support wall 1110. Sliding the side rails 1112 along the track 1114 may enable a user to slide the intermediate grate 112B out of the cooking chamber 130 enabling a user to easily position and/or remove a food item on the grate 112B without leaning into the cooking chamber 130.

In some embodiments, the intermediate grate 112B may include a raised portion 1116. The raised portion 1116 of the grate 112B may be positioned on a rear portion of the intermediate grate 112B. In some embodiments, the raised portion 1116 of the grate 112B may be configured to interface with a bottom surface of the ridges, such that the raised portion 1116 may substantially prevent the grate 112B from tipping or rotating out of the track 1114 due to a moment induced by a food item positioned on the grate 112B. In some embodiments, the raised portion 1116 may be configured to interface with a stop 1118 on the track 1114. The stop 1118 may be configured to stop the intermediate grate 112B from unintentionally sliding off an end of the track 1114. For example, the stop 1118 may be a portion of the track 1114 that extends below the bottom surface of the upper track, such that the side rails 1112 do not contact the stop 1118 but the raised portion 1116 of the grate 112B may contact the stop 1118. In some embodiments, the stop 1118 may be configured to be bypassed through a purposeful movement of the grate 112B, such as tilting the grate 112B to a large angle, such that the raised portion 1116 of the grate 112B may bypass the stop 1118.

In some embodiments, the tracks 1114 may be a sliding track, such as interlocking metal slides, roller slides, ball bearing slides, etc., configured to contact a top surface and bottom surface of the side rails 1112. In some embodiments, the sliding track may include internal stops that may be released by pressing a button or tilting the grate 112B to a deliberate angle to bypass the stop.

The support walls 1110 may further include a rear grate latch 1120 configured to interface with the raised portion 1116 of the intermediate grate 112B substantially securing the intermediate grate 112B in position relative to the support walls 1110, when the intermediate grate 112B is fully inserted into the support walls 1110 on the track 1114.

In some embodiments, the support walls 1110 may include multiple different tracks 1114 positioned at different heights, such that the intermediate grate 112B may be moved to different tracks 1114 to move the food being cooked on the intermediate grate with respect to the heat source. For example, moving the intermediate grate 112B to a higher track may move the food being cooked farther away from the heat source, resulting in a slower cooking time and moving the intermediate grate 112B to a lower track 1114 may result in a higher temperature resulting in a faster cooking time. Thus, cooking characteristics for different foods may be adjusted by changing a vertical position of the intermediate grate 112B.

FIG. 20C illustrates an embodiment of an upper grate 112C. The upper grate 112C may be coupled to a top portion of the support walls 1110. For example, the upper grate 112C may be coupled to the support walls 1110 in an area above the tracks 1114. The upper grate 112C may include side supports 1122. The side supports 1122 may be configured to couple the support rails 1104 to the support walls 1110. For example, the side supports 1122 may interface with a mounting feature 1124 in the support walls 1110. In some embodiments, the mounting feature may be a protrusion configured to interface with a complementary shape in the side supports 1122. In some embodiments, the support walls 1110 may include a recess or aperture configured to receive a complementary feature, such as a foot, a protrusion, a bar, etc., extending from the side supports 1122. In some embodiments, the aperture and/or complementary feature may substantially prevent the intermediate grate 112B from being placed in an unstable position above the top track 1114.

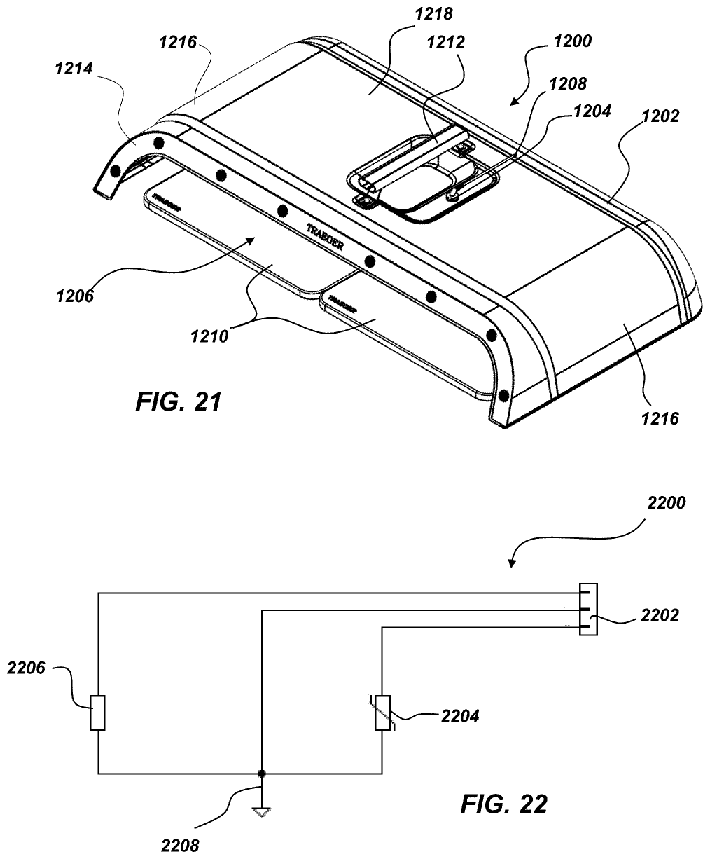

FIG. 21 illustrates a pizza oven 1200 that may be configured as a cooking accessory to interface with the base grates 112A in the manner discussed above. The pizza oven 1200 may include a cover 1202 defining a cooking chamber 1206 with a reduced volume compared to the cooking chamber 130 of the grill device 100. The reduced volume of the cooking chamber 1206 may enable the temperature of the pizza oven 1200 to reach a higher temperature than the cooking chamber 130 of the grill device 100. The pizza oven 1200 may include a temperature sensor 1204 configured to measure the temperature inside cooking chamber 1206 of the pizza oven 1200. The temperature sensor 1204 may be a resistance type temperature sensor (e.g., a resistance temperature detector (RTD) or thermistor) or a thermocouple. The temperature sensor 1204 may be configured to be coupled to the controller 106 through an electrical connection 1208.

When the pizza oven 1200 is being used, the controller 106 may alter the configuration of the grill device 100 to operate the pizza oven 1200. For example, the controller 106 may control the grill device 100 based on the temperate readings from the temperature sensor 1204 measuring the temperature in the cooking chamber 1206 of the pizza oven 1200. The controller 106 may control the grill device 100 to higher temperatures in the cooking chamber 1206 than would normally be used within the grill device 100 if the pizza oven 1200 were not coupled to the grill device 100.

The pizza oven 1200 may include one or more pizza stones 1210. The pizza stones 1210 may be configured to withstand high temperatures, such as the high temperatures in the cooking chamber 1206. For example, the pizza stones 1210 may be formed from materials, such as clay, ceramic, cordierite.

The cover 1202 may be configured to form a top and at least two sides of the cooking chamber 130. The cover 1202 may include side walls 1216 coupled to a top wall 1218. In some embodiments, the top wall 1218 may be substantially planar extending between the side walls 1216. The side walls 1216 may be configured to interface with the base grate 112A (FIG. 20A). For example, the side walls 1216 may include protruding features configured to nest into the nesting features of the base grate 112A. In some embodiments, the side walls 1216 may include a curved transition to the top wall 1218. In other embodiments, the interface between the side walls 1216 and the top wall 1218 may form a hard transition (e.g., corner, edge, etc.).

The cover 1202 may include a flange 1214 around an opening to the cooking chamber 1206. The flange 1214 may be configured to add structural support to the cover 1202 around the opening to the cooking chamber 1206. In some embodiments, the flange 1214 may reduce the heat lost from the cooking chamber 1206 of the pizza oven 1200 to the cooking chamber 130 of the grill device 100. In some embodiments, the cover 1202 may have an opening to the cooking chamber 1206 on two sides (e.g., front and back) of the pizza oven 1200. In other embodiments, the cover 1202 may only have one opening into the cooking chamber 1206, such as in a front portion of the pizza oven 1200. The cover 1202 may be formed from a thin heat resistant material, such as a metal material (e.g., steel, aluminum, stainless steel, etc.)

In some embodiments, the cover 1202 may include a handle 1212 coupled to the top wall 1218 of the cover 1202. The handle 1212 may be configured to enable a user to insert and remove the cover 1202 from the cooking chamber 130 of the grill device 100 without touching the top wall 1218 or side walls 1216 of the cover 1202. The top wall 1218 and side walls 1216 of the cover 1202 may become coated in cooking by-products, such as grease, oil, soot, ash, etc., such that removing the cover 1202 by grasping the walls 1216, 1218 of the cover 1202 may create a mess. The handle 1212 may enable the user to remove the cover 1202 without creating an unnecessary mess. In some embodiments, the handle 1212 may be formed from a heat insulating material, such as wood, plastic, etc., such that cover 1202 may be removed while the cover 1202 is still hot from a cooking operation by grasping the handle 1212.

In some embodiments, the electrical connections 1208, 1830 of the different cooking accessories may have universal plugs. For example, the electrical connections 1208, 1830 may each be configured to plug into any of the sockets 202 (FIG. 14) in the power strip 200 of the grill device 100. Thus, the grill device 100 may be arranged into multiple different cooking configurations based on the different cooking accessories by plugging the associated cooking accessory into the sockets 202.

FIG. 22 illustrates a wiring diagram of a cooking accessory wiring 2200 (e.g., pizza oven 1200). The cooking accessory wiring 2200 may include a plug 2202. The plug 2202 may include at least three connections, such as pins, sockets, etc. At least one of the connections may include an identifying device 2206, such as an identifying resistor. The different cooking accessories may have different identifying resistors (e.g., having a different resistance), such that the controller 106 may determine which type of cooking accessory is plugged into the socket 202 based on the resistance of the identifying resistor. At least one of the connections may be a neutral connection 2208, such as a ground (e.g., sensor ground, earth ground, etc.), common (e.g., common voltage, reference voltage, etc.), etc. At least one of the connections may be a device or sensor connection 2204. For example, the device or sensor connection 2204 may be a sensor, such as a temperature sensor in the cooking accessory (e.g., temperature sensor 1204, sensor 1828, etc.). In some embodiments, the device or sensor connection 2204 may be a power connection for the cooking accessory that may be routed into the cooking accessory to either power the cooking accessory or to be routed through sensors.

In some embodiments, the controller 106 may determine how to configure or interpret the device or sensor connection 2204 based on the identifying device 2206. For example, if the induction hob 1800 is connected to the socket 202, the controller 106 may supply power to the induction hob 1800 through the device or sensor connection 2204 and control/monitor the induction hob 1800 through a wireless connection. In another case, if the pizza oven 1200 is connected to the socket 202, the controller 106 may monitor the temperature of the cooking chamber 1206 through the temperature sensor 1204 connected through the device or sensor connection 2204 of the pizza oven 1200.

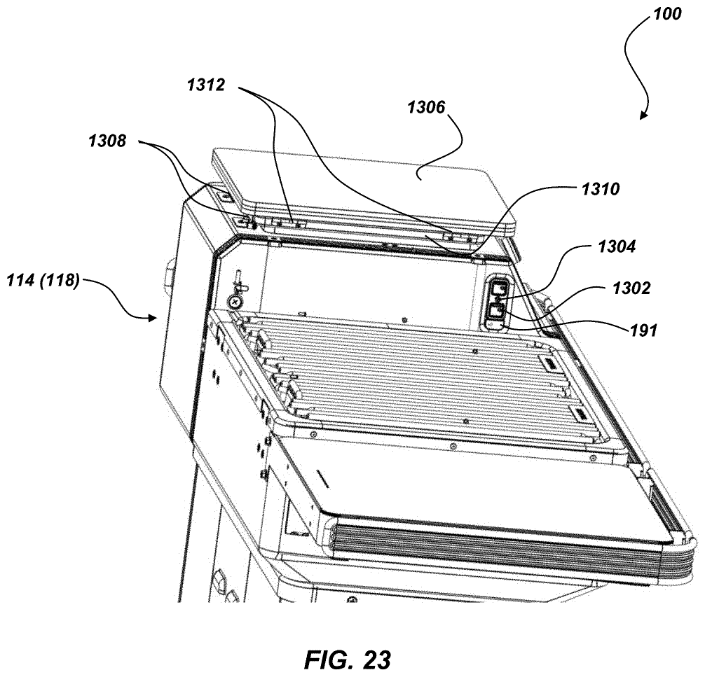

FIG. 23 illustrates a perspective view of the grilling device with the lid 110 and several components of the cooking chamber 130 removed to allow details of the fuel storage chamber 114 and hopper 118 to be seen. The hopper 118 may include one or more lights 1302 positioned on a side of the hopper 118 facing the cooking chamber 130. In some embodiments, the lights 1302 may be configured to be manually turned on, such as through a switch or controller output. In some embodiments, the lights 1302 may be turned on by a sensor, such as a light sensor, a proximity sensor (e.g., magnetic sensor, radio frequency sensor, etc.), the lid sensor 191 (e.g., lid open switch, contact switch, etc.), or a combination of sensors and/or switches. For example, a sensor such as a proximity sensor or lid sensor may detect when the lid 110 is opened. In another example, the lid sensor 119, may be a magnetic sensor aligned with a magnet on the lid 110 and configured to detect a presence or proximity of the magnet on the lid 110. Once the lid 110 is opened the light 1302 may turn on illuminating the cooking chamber 130. In some embodiments, a light sensor may prevent the lights 1302 from turning on when it is light outside. For example, a sensor may detect if the lid 110 is opened and a light sensor may determine if it is light in the area around the grill. If the light sensor determines that the ambient light around the grill is insufficient to light the cooking chamber the lights 1302 may turn on when the lid 110 is opened. In some embodiments, a brightness of the lights 1302 may be adjusted, such as through pulse width modulation (PWM) or varying the voltage supplied to the lights 1302. For example, the brightness of lights 1302 may be adjusted based on ambient light, such that as the ambient light decreases the brightness of the lights 1302 increases. In another example, the brightness of the lights 1302 may be adjusted based on the cooking status of the grill device 100. For example, the brightness of the lights 1302 may increase when the item being cooked approaches the end of the cooking cycle to enable the user to better check the status of the item being cooked.

Lighting the cooking chamber 130 may enable a user to inspect and/or check food items cooking in the cooking chamber 130 when ambient light in an area around the grill device 100 is insufficient for the user to be able to inspect the cooking chamber. In some embodiments, lighting the cooking chamber 130 may enable a user to accurately assess food items cooking in the cooking chamber 130 regardless of the ambient light conditions in the area around the grill device 100.

Positioning the lights 1302 on a surface of the hopper 118 may maintain the lights 1302 in a substantially constant position relative to the cooking chamber 130. For example, the hopper 118 and the cooking chamber 130 may remain in substantially the same position relative to one another, whereas other components such as the lid 110, may move relative to the cooking chamber 130. Positioning the lights 1302 such that the lights 1302 are in a substantially constant position relative to the cooking chamber 130 may provide consistent light for the user, such that any adjustments to the position, angle, brightness, etc., of the lights 1302 may remain consistent between uses. Consistent light may enable the user to better assess the status of the food items cooking in the cooking chamber 130. Furthermore, positioning the lights 1302 on the surface of the hopper 118 may enable the lights 1302 to be positioned outside of the direct heat and smoke of the cooking chamber 130. Positioning the lights 1302 outside of the direct heat and smoke of the cooking chamber 130 may extend a life of the lights 1302. For example, positioning the lights 1302 outside the heat of the cooking chamber 130 may substantially prevent the lights 1302 and/or components of the lights 1302 from melting in the heat of the cooking chamber 130. Positioning the lights 1302 outside the smoke of the cooking chamber 130 may substantially prevent ash from settling on the lights 1302 obstructing the light. In some embodiments, positioning the lights 1302 outside the heat and/or smoke of the cooking chamber 130 may substantially prevent discoloration of the lenses of the lights 1302 from the heat and/or smoke, such that an intensity of the light from the lights 1302 may be substantially maintained. In some embodiments, the lights 1302 may include a cooling device, such as a fan configured to cool the electronics of the lights 1302 further extending the life of the lights 1302.

The hopper 118 may include a lid 1306 configured to provide access to the fuel storage chamber 114 within the hopper. For example, the lid 1306 may be configured to open by rotating relative to the hopper 118 about a first set of hinges 1308. Once the lid 1306 is open the user may have access to the fuel storage chamber 114 within the hopper 118. Thus, opening the lid 1306 may enable the user to inspect, add, remove, and/or change fuel, such as wood pellets, in the fuel storage chamber 114.

In some embodiments, the lid 1306 may include a secondary storage chamber 1310. For example, the secondary storage chamber 1310 may be a small cavity within the lid 1306 configured to store grilling accessories, such as heat pads, spatulas, tongs, temperature probes, sensor probes, connectors, plugs, replacement parts, etc. The lid 1306 may open to the secondary storage chamber 1310 by rotating about a second set of hinges 1312. In some embodiments, the second set of hinges 1312 may be positioned on a different side of the lid 1306 from the first set of hinges 1308, such that the lid opens in different directions to open the different storage compartments (e.g., secondary storage chamber 1310 and the fuel storage chamber 114).

In some embodiments, the lid 1306 may be further configured to act as a meal preparation surface, such as a cutting board, shelf, or table. In other embodiments, the lid may be configured to attach other external cooking accessories to the grilling device 1000, such as the induction hob 1800, described above.

Non-limiting example embodiments of the present disclosure may include:

Embodiment 1: A grill device, comprising: a cooking portion assembly, comprising: a fire pot assembly; an ash-collection container; a bottom plate extending between the fire pot assembly and the ash-collection container; a drip tray disposed above the fire pot assembly and ash-collection container; a cooking chamber defined above the drip tray; and an expansion chamber defined beneath the drip tray and above the fire pot assembly, the ash-collection container, and the bottom plate, wherein the expansion chamber is configured to facilitate particulate within smoke produced by combustion within the fire pot assembly to fall out of the smoke before the smoke reaches the cooking chamber.

Embodiment 2: The grill device of embodiment 1, wherein the bottom plate extends from upper outer peripheral edges of the fire pot assembly and the ash-collection container and defines a peak between the fire pot assembly and the ash-collection container.

Embodiment 3: The grill device of embodiment 2, wherein the peak is more proximate the fire pot assembly than the ash-collection container, and wherein the upper outer peripheral edge of the fire pot assembly and the upper outer peripheral edge of the ash-collection container are at least substantially coplanar.

Embodiment 4: The grill device of any one of embodiments 1 through 3, wherein the drip tray comprises a plurality of distinct sloping surfaces defining a downward funnel having an opening above the ash-collection container.

Embodiment 5: The grill device of any one of embodiments 1 through 4, further comprising a heat shield disposed between the drip tray and the bottom plate.

Embodiment 6: The grill device of embodiment 5, wherein the heat shield includes a plurality of apertures extending therethrough, and wherein a concentration of apertures of the plurality of apertures increases as a distance from the fire pot assembly increases.

Embodiment 7: The grill device of any one of embodiments 1 through 6, further comprising:
an outer wall; and an air gap defined between the outer wall and outer surfaces of the fire pot assembly and the ash-collection container.

Embodiment 8: The grill device of any one of embodiments 1 through 7, wherein the fire pot assembly comprises: two opposing inclined walls extend upward from a base wall; and two opposing side walls extending between the two opposing inclined walls at longitudinal ends of the two opposing inclined walls, wherein the two opposing inclined walls and the two opposing side walls define a rectangular opening opposite the base wall.

Embodiment 9: The grill device of embodiment 8, wherein the fire pot assembly comprises a truncated triangle prism shape with a truncated end of the triangle prism facing downward.

Embodiment 10: The grill device of any one of embodiments 8 or 9, further comprising a fuel movement assembly disposed at least a partially above the fire pot assembly and configured to drop fuel into the fire pot assembly from above the fire pot assembly.

Embodiment 11: The grill device of any one of embodiments 8 through 10, wherein each of the two opposing inclined walls of the fire pot assembly comprise a plurality of apertures extending therethrough.

Embodiment 12: The grill device of any one of embodiments 8 through 11, wherein the fire pot assembly further comprises an igniter extending at least partially through the base wall.

Embodiment 13: A grill device, comprising: a cooking portion assembly, comprising: a fire pot assembly; a flame sensor configured to detect flames within the fire pot assembly; a fuel chamber for housing fuel of the grill device; a fuel sensor disposed within the fuel chamber and configured to detect a fuel feed rate from the fuel chamber into the fire pot assembly; a cover defining a portion of a cooking chamber and openable relative a remainder of the cooking portion assembly; and a lid sensor coupled configured to detect a position of the cover; and a controller operably coupled to the flame sensor, the fuel sensor, and the lid sensor, the controller comprising: at least one processor; and at least one non-transitory computer-readable storage medium storing instructions thereon that, when executed by the at least one processor, cause the controller to: receive information regarding operation of the grill device from at least one of the flame sensor, the fuel sensor, and or lid sensor; adjust combustion of fuel within the fire pot assembly based at least partially on the received information by adjusting a fuel feed rate; and verify the adjusted fuel feed rate via the fuel sensor.

Embodiment 14: The grill device of embodiment 13, wherein receiving information regarding operation of the grill device from at least one of the flame sensor, the fuel sensor, and or lid sensor comprises receiving an indication from the lid sensor that the cover of the grill device is open.

Embodiment 15: The grill device of any one of embodiments 13 or 14, wherein receiving information regarding operation of the grill device from at least one of the flame sensor, the fuel sensor, and or lid sensor comprises receiving an indication from the flame sensor that flames are present within the fire pot assembly.

Embodiment 16: The grill device of embodiment 15, wherein receiving an indication from the flame sensor that flames are present within the fire pot assembly comprises receiving information regarding one or more of the flames' color, temperature, or size.

Embodiment 17: The grill device of any one of embodiments 13 through 16, wherein the flame sensor comprises one or more of an infrared light sensor, an infrared thermal camera, an optical sensor, a byproduct sensor, a thermocouple, an ultraviolet light detector, or an ionization current flame detector.

Embodiment 18: The grill device of any one of embodiments 13 through 17, wherein the fuel sensor comprises a mechanical switch configured to sense a flow rate of fuel.

Embodiment 19: The grill device of any one of embodiments 13 through 18, further comprising a temperature sensor operably coupled to the controller and disposed within the cooking portion assembly.

Embodiment 20: The grill device of embodiment 19, wherein temperature sensor comprises a multi junction thermocouple spanning a majority of a length of the cooking chamber of the cooking portion assembly.

Embodiment 21: The grill device of any one of embodiments 13 through 20, further comprising a smoke sensor operably coupled to the controller and disposed within the cooking portion assembly.

Embodiment 22: The grill device of embodiment 21, wherein the smoke sensor comprises one or more of a smoke color sensor or a smoke density sensor.

Embodiment 23: The grill device of any one of embodiments 13 through 22, further comprising one or more of a gas detection sensor, a volatile organic compound sensors, or particulate matter sensors operably coupled to the controller.

Embodiment 24: A grill device, comprising: a cooking portion assembly, comprising: a cooking chamber; a temperature sensor disposed within the cooking chamber; and a plurality of other sensors discrete from the temperature sensors disposed within the cooking portion assembly, and a controller operably coupled to the temperature sensor and the plurality of other sensors, the controller comprising: at least one processor; and at least one non-transitory computer-readable storage medium storing instructions thereon that, when executed by the at least one processor, cause the controller to: receive information regarding operation of the grill device from at least one of the plurality of other sensors; and adjust combustion of fuel within the cooking portion assembly based at least partially on the received information.

Embodiment 25. The grill device of embodiment 24, wherein adjusting combustion of fuel within the cooking portion assembly comprises adjusting a fuel feed rate into a fire pot assembly.

Embodiment 26. The grill device of any one of embodiments 24 or 25, wherein adjusting combustion of fuel within the cooking portion assembly comprises adjusting an ignition cycle.

Embodiment 27: The grill device of any one of embodiments 24 through 26, wherein receiving information regarding operation of the grill device from at least one of the plurality of sensors comprises receiving an indication that a lid of the grill device is at least partially open.

Embodiment 28: The grill device of any one of embodiments 24 through 27, wherein receiving information regarding operation of the grill device from at least one of the plurality of sensors comprises receiving an indication that flames are present within a fire pot assembly of the cooking portion assembly.

Embodiment 29: The grill device of embodiment 28, wherein receiving an indication that flames are present within the fire pot assembly comprises receiving information regarding one or more of the flames' color, temperature, or size

Embodiment 30: The grill device of any one of embodiments 24 through 29, the plurality of sensors comprises a flame sensor, a fuel sensor, and a lid sensor.

Embodiment 31: The grill device of any one of embodiments 24 through 31, further comprising a smoke sensor operably coupled to the controller and disposed within the cooking portion assembly.

Embodiment 32: The grill device of embodiment 31, wherein the smoke sensor comprises one or more of a smoke color sensor or a smoke density sensor.

Embodiment 33: A grill device, comprising: a cooking portion assembly comprising a cover pivotally coupled to a remainder of the cooking portion assembly, the cover being openable to expose a cooking chamber of the grill device; a cover opener sensor configured to detect motion or a proximity of an object; and a controller operably coupled to the cover opener sensor, the controller comprising: at least one processor; and at least one non-transitory computer-readable storage medium storing instructions thereon that, when executed by the at least one processor, cause the controller to: receive indication from the cover opener sensor that motion has been detected or that an object is proximate the cover opener sensor; and cause the cover of the cooking portion assembly to open.

Embodiment 34: The grill device of embodiment 33, wherein the cover opener sensor comprises an optical sensor.

Embodiment 35: The grill device of any one of embodiments 33 or 34, further comprising a motor or solenoid coupled to the cover opener sensor and configured to open and close the cover of the grill device in response to instructions from the controller.

Embodiment 36: A grill device, comprising: a cooking portion assembly comprising: a cooking chamber; and a hopper comprising: a housing for holding fuel of the grill device; and one or more radio frequency transparent windows formed in the housing; and a controller disposed within the hopper and for controlling operation of the grill device, the controller comprising at least one antenna enclosed by the housing of the hopper.

Embodiment 37: The grill device of embodiment 36, wherein the one or more radio frequency transparent windows comprise a polymer material.

Embodiment 38: A grill device, comprising: a cooking portion assembly, comprising: a fire pot assembly; an ash-collection container; a bottom plate extending between the fire pot assembly and the ash-collection container; a drip tray disposed above the fire pot assembly and ash-collection container; and a cooking chamber defined above the drip tray; an outer wall defining an exterior of at least a portion of the cooking portion assembly, wherein an air gap is defined between the outer wall and outer surfaces of the fire pot assembly and the ash-collection container; and a controller comprising: at least one processor; and at least one non-transitory computer-readable storage medium storing instructions thereon that, when executed by the at least one processor, cause the controller to control operation of the grill device.

Embodiment 39: The grill device of embodiment 38, wherein the ash-collection container comprises a cylindrical canister comprising at least one disposable portion.

Embodiment 40: The grill device of any one of embodiments 38 or 39, wherein the bottom plate extends from upper outer peripheral edges of the fire pot assembly and the ash-collection container and defines a peak between the fire pot assembly and the ash-collection container.

Embodiment 41: The grill device of any one of embodiments 38 through 40, wherein the ash-collection container comprises a grease sensor configured to detect an amount of material within the ash-collection container.

Embodiment 42: The grill device of embodiment 41, wherein the grease sensor comprises at least one of a scale or an optical sensor.

Embodiment 43: The grill device of any one of embodiments 38 through 42, further comprising: a hopper and auger system for storing and providing fuel to the fire pot assembly; and a power strip coupled to the hopper and comprising one or more sockets for providing one or more of power of data transfer.

Embodiment 44: A grill device, comprising: a controller for controlling operation of the grill device; and one or more proximity sensor operably coupled to the controller and configured to detect objects proximate the grill device.

Embodiment 45: The grill device of embodiment 44, wherein the one or more proximity sensors comprise one or more of a capacitive proximity sensor, a photoelectric sensor, an inductive proximity sensor, a magnetic sensor, an optical sensor, RFID distance sensor, or a Hall Effect sensor.

Embodiment 46: A grill device, comprising: a controller for controlling operation of the grill device; and a universal accessory jack operably coupled to the controller of the grill device and configured to accept connectors from a plurality of grill accessories, wherein the controller is configured to determine a type of grill accessory connected to the universal accessory jack.

Embodiment 47: The grill device of embodiment 46, wherein the controller is configured to determine a type of grill accessory connected to the universal accessory jack based at least partially on a mechanical interference between the universal accessory jack and a connector of the universal accessory jack.

Embodiment 48: The grill device of any one of embodiments 46 or 47, wherein the controller is configured to determine a type of grill accessory connected to the universal accessory jack based at least partially on data received from the grill accessory.

Embodiment 49: The grill device of any one of embodiments 46 through 48, wherein the controller is configured to adjust one or more cooking parameters of the grill device based at least partially on the detected type of grill accessory connected to the universal accessory jack.

Embodiment 50: A grill device, comprising: a controller for controller operation of the grill device; and a wireless sensor probe in wireless communication with the controller.

Embodiment 51: The grill device of embodiment 50, wherein the wireless sensor probe comprises power sources comprising a capacitive energy storage device.

Embodiment 52: The grill device of any one of embodiments 50 or 51, further comprising a transmitting coil of an induction charging system, and wherein the wireless sensor probe comprises a receiving coil of the induction charging system.

Embodiment 53: The grill device of any one of embodiments 50 through 52, wherein the wireless sensor probe is configured to communicate with the controller via Bluetooth.

Embodiment 54: A grill device, comprising: a cooking portion assembly having a cover defining a portion of a cooking chamber and openable relative a remainder of the cooking portion assembly, wherein the cover comprises an exhaust port formed therein; and a particulate filter disposed in the exhaust port and configured to filter exhaust escaping the grill device.

Embodiment 55: A controller of a grill device, the controller comprising a modular printed circuit board, comprising: a single motherboard having a plurality of slots for receiving other boards, wherein the single motherboard is dedicated to control core operations of the grill device; a plurality of first boards removably coupled to slots of the plurality of slots, each of the plurality of first boards being dedicated to control a respective additional feature of the grill device; and a plurality of second boards removably coupled to slots of the plurality of slots, each of the plurality of first boards being dedicated to control a respective user interface of the grill device.

The embodiments of the disclosure described above and illustrated in the accompanying drawings do not limit the scope of the disclosure, which is encompassed by the scope of the appended claims and their legal equivalents. Any equivalent embodiments are within the scope of this disclosure. Indeed, various modifications of the disclosure, in addition to those shown and described herein, such as alternate useful combinations of the elements described, will become apparent to those skilled in the art from the description. Such modifications and embodiments also fall within the scope of the appended claims and equivalents.

What is claimed is:

1. A grill device, comprising:
a cooking portion assembly, comprising:
a fire pot assembly;
an ash-collection container;
a bottom plate extending between the fire pot assembly and the ash-collection container;
a drip tray disposed above the fire pot assembly and ash-collection container;
a cooking chamber defined above the drip tray; and
an expansion chamber defined beneath the drip tray and above the fire pot assembly, the ash-collection container, and the bottom plate, wherein the expansion chamber is configured to facilitate particulate within smoke produced by combustion within the fire pot assembly to fall out of the smoke before the smoke reaches the cooking chamber.

2. The grill device of claim 1, wherein the drip tray comprises a plurality of distinct sloping surfaces defining a downward funnel having an opening above the ash-collection container.

3. The grill device of claim 1, further comprising a heat shield disposed between the drip tray and the bottom plate.

4. The grill device of claim 3, wherein the heat shield includes a plurality of apertures extending therethrough, and wherein a concentration of apertures of the plurality of apertures increases as a distance from the fire pot assembly increases.

5. The grill device of claim 1, further comprising:
an outer wall; and
an air gap defined between the outer wall and outer surfaces of the fire pot assembly and the ash-collection container.

6. The grill device of claim 1, wherein the fire pot assembly comprises:
two opposing inclined walls extend upward from a base wall; and
two opposing side walls extending between the two opposing inclined walls at longitudinal ends of the two opposing inclined walls,
wherein the two opposing inclined walls and the two opposing side walls define a rectangular opening opposite the base wall.

7. The grill device of claim 6, further comprising a fuel movement assembly disposed at least a partially above the fire pot assembly and configured to drop fuel into the fire pot assembly from above the fire pot assembly.

8. The grill device of claim 6, wherein each of the two opposing inclined walls of the fire pot assembly comprise a plurality of apertures extending therethrough.

9. The grill device of claim 6, wherein the fire pot assembly further comprises an igniter extending at least partially through the base wall.

10. A grill device, comprising:
a cooking portion assembly, comprising:
a fire pot assembly;
a flame sensor configured to detect flames within the fire pot assembly;
a fuel chamber for housing fuel of the grill device;
a fuel sensor disposed within the fuel chamber and configured to detect a fuel feed rate from the fuel chamber into the fire pot assembly;
a cover defining a portion of a cooking chamber and openable relative a remainder of the cooking portion assembly; and
a lid sensor coupled configured to detect a position of the cover; and
a controller operably coupled to the flame sensor, the fuel sensor, and the lid sensor, the controller comprising:
at least one processor; and
at least one non-transitory computer-readable storage medium storing instructions thereon that, when executed by the at least one processor, cause the controller to:
receive information regarding operation of the grill device from at least one of the flame sensor, the fuel sensor, and or lid sensor;
adjust combustion of fuel within the fire pot assembly based at least partially on the received information by adjusting a fuel feed rate; and
verify the adjusted fuel feed rate via the fuel sensor.

11. The grill device of claim 10, wherein receiving information regarding operation of the grill device from at least one of the flame sensor, the fuel sensor, and or lid sensor comprises at least one of receiving an indication from the lid sensor that the cover of the grill device is open, receiving an indication from the flame sensor that flames are present within the fire pot assembly, or receiving information regarding one or more of the flames' color, temperature, or size.

12. The grill device of claim 10, wherein the flame sensor comprises one or more of an infrared light sensor, an infrared thermal camera, an optical sensor, a byproduct sensor, a thermocouple, an ultraviolet light detector, or an ionization current flame detector.

13. The grill device of claim 10, wherein the fuel sensor comprises a mechanical switch configured to sense a flow rate of fuel.

14. The grill device of claim 10, further comprising a smoke sensor operably coupled to the controller and disposed within the cooking portion assembly.

15. The grill device of claim 14, wherein the smoke sensor comprises one or more of a smoke color sensor or a smoke density sensor.

16. The grill device of claim 10, further comprising one or more of a gas detection sensor, a volatile organic compound sensors, or particulate matter sensors operably coupled to the controller.

17. A grill device, comprising:
a cooking portion assembly, comprising:
a cooking chamber;
a temperature sensor disposed within the cooking chamber; and
a plurality of other sensors discrete from the temperature sensors disposed within the cooking portion assembly, and
a controller operably coupled to the temperature sensor and the plurality of other sensors, the controller comprising:
at least one processor; and
at least one non-transitory computer-readable storage medium storing instructions thereon that, when executed by the at least one processor, cause the controller to:
receive information regarding operation of the grill device from at least one of the plurality of other sensors; and
adjust combustion of fuel within the cooking portion assembly based at least partially on the received information.

18. The grill device of claim 17, wherein adjusting combustion of fuel within the cooking portion assembly comprises at least one of adjusting a fuel feed rate into a fire pot assembly or adjusting an ignition cycle.

19. The grill device of claim 17, further comprising a smoke sensor operably coupled to the controller and disposed within the cooking portion assembly.

20. The grill device of claim 19, wherein the smoke sensor comprises one or more of a smoke color sensor or a smoke density sensor.
